(19) United States
(12) Patent Application Publication
(10) Pub. No.: US 2026/0085630 A1
(43) Pub. Date: Mar. 26, 2026

(54) OPPOSED-PISTON ENGINE

(71) Applicant: Kubota Corporation, Osaka (JP)

(72) Inventor: Taro FUKUDA, Ota-shi (JP)

(21) Appl. No.: 19/407,793

(22) Filed: Dec. 3, 2025

Related U.S. Application Data
(63) Continuation of application No. PCT/JP2023/027888, filed on Jul. 31, 2023.

(51) Int. Cl. F02B 75/24; F01L 1/14; F01L 1/18

(52) U.S. Cl. CPC F02B 75/24; F01L 1/146; F01L 1/18

(57) ABSTRACT

An opposed-piston engine includes a cylinder, a first piston in the cylinder, a second piston in the cylinder and opposed to the first piston, a first crankshaft to rotate as the first piston rotates, a second crankshaft to rotate as the second piston rotates, a valve to perform an operation to intake or exhaust air into or from the cylinder, and a power transmission to transmit the rotational power of the first crankshaft to the valve to cause the valve to perform the operation. The first crankshaft and the second crankshaft are juxtaposed with a space therebetween in an alignment direction in which the first piston and the second piston are aligned. The power transmission extends in the alignment direction to a position corresponding to the first crankshaft and to a position corresponding to the second crankshaft across the space therebetween.

### CROSS REFERENCE TO RELATED APPLICATIONS

This application is a continuation application of International Application No. PCT/JP2023/027888, filed on Jul. 31, 2023. The entire contents of this application are hereby incorporated herein by reference.

### BACKGROUND OF THE INVENTION

### 1. Field of the Invention

The present invention relates to opposed-piston engines each including at least two pistons opposed to each other.

### 2. Description of the Related Art

An opposed-piston engine is known as disclosed in Japanese Unexamined Patent Application Publication No. 2019-90424. The opposed-piston engine disclosed in Japanese Unexamined Patent Application Publication No. 2019-90424 includes at least two pistons opposed to each other, two crankshafts that rotate as the respective pistons reciprocate, and a valve driving mechanism to control at least one intake valve and at least one exhaust valve.

### SUMMARY OF THE INVENTION

The valve driving mechanism of the opposed-piston engine disclosed in Japanese Unexamined Patent Application Publication No. 2019-90424 includes at least one crank pulley, at least one cam pulley, and at least one timing belt looped over the at least one crank pulley and the at least one cam pulley. In the present valve driving mechanism, the at least one timing belt includes timing belts that are looped over respective crank pulleys of the two crankshafts. For this reason, it is difficult to reduce or minimize the mechanism to transmit rotational powers from the crankshafts to the valves.

Example embodiments of the present invention provide opposed-piston engines that reduce or minimize a mechanism to transmit a rotational power from crankshafts to valves.

Example embodiments of the present invention may include the following features.

According to an example embodiment of the present invention, an opposed-piston engine includes a cylinder, a first piston provided in the cylinder, a second piston provided in the cylinder and opposed to the first piston, a first crankshaft to rotate as the first piston reciprocates, a second crankshaft to rotate as the second piston reciprocates, at least one valve to perform an operation to intake or exhaust air into or from the cylinder, and a power transmission to transmit a rotational power of the first crankshaft to the at least one valve so as to cause the at least one valve to perform the operation. The first crankshaft and the second crankshaft are juxtaposed with a space therebetween in an alignment direction in which the first piston and the second piston are aligned. The power transmission extends in the alignment direction to a position corresponding to the first crankshaft and to a position corresponding to the second crankshaft across the space therebetween.

The power transmission may include a camshaft to rotate as the first crankshaft rotates, at least one pushrod to reciprocate as the camshaft rotates, and at least one rocker arm to connect the at least one pushrod to the at least one valve. A first end of opposite ends of the at least one pushrod may be provided on a same side as the first crankshaft, a second end of the opposite ends of the at least one pushrod may be provided on a same side as the second crankshaft, and the at least one rocker arm on a same side as the second crankshaft may operably connect the second end of the at least one crankshaft to the at least one valve.

The camshaft may include a single camshaft provided on a same side as the first crankshaft in the alignment direction.

The at least one valve may include an intake valve and an exhaust valve. The intake valve and the exhaust valve may be configured to perform the respective operations as the single camshaft rotates.

The camshaft may include a shaft and at least one cam provided on the shaft, and the first end of the at least one pushrod may abut the at least one cam.

A proximal end of a first valve that is one of the intake valve or the exhaust valve may abut the at least one rocker arm. A proximal end of a second valve that is another of the intake valve or the exhaust valve may abut a rocker which is interlocked with the at least one cam.

The first valve may be the exhaust valve, and the second valve may be the intake valve.

The first piston and the second piston may be aligned in a horizontal direction. The camshaft may be provided above the first crankshaft.

The at least one pushrod may include a first pushrod and a second pushrod. The at least one cam may include a first cam and a second cam spaced at a distance from each other in an extending direction of the camshaft. The first end of the first pushrod may abut the first cam, and the first end of the second pushrod may abut the second cam.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a perspective view of an engine according to an example embodiment of the present invention when viewed from the front left.

FIG. 2 is a perspective view of an engine according to an example embodiment of the present invention when viewed from the rear right.

FIG. 3 is a side view of an engine according to an example embodiment of the present invention when viewed from the right.

FIG. 4 is a front view of an engine according to an example embodiment of the present invention.

FIG. 5 is a longitudinal section view sectioned in a vertical direction at a position of an intake passage of an engine according to an example embodiment of the present invention.

FIG. 6 is a longitudinal section view sectioned in a vertical direction at a position of an exhaust passage of an engine according to an example embodiment of the present invention.

FIG. 7 is a longitudinal section view sectioned in a horizontal direction of an engine according to an example embodiment of the present invention.

FIG. 8 is a perspective view illustrating an internal structure of an engine according to an example embodiment of the present invention.

FIG. 9 is a top view illustrating an internal structure of an engine according to the example embodiment of the present invention.

FIG. 10 is a front view illustrating an internal structure of an engine according to the example embodiment of the present invention.

FIG. 11 is a right side view illustrating an internal structure of an engine according to the example embodiment of the present invention.

FIG. 12 is a left side view illustrating an internal structure of an engine according to an example embodiment of the present invention.

FIG. 13 is a perspective view illustrating a power transmission to actuate intake valves and exhaust valves.

FIG. 14 is a perspective view illustrating a power transmission to actuate an exhaust valve.

FIG. 15 is a perspective view illustrating a power transmission to actuate an intake valve.

FIG. 16 is a right side view illustrating a power transmission to actuate an intake valve.

FIG. 17 is a perspective view illustrating a decompressor.

FIG. 18 illustrates an engine according to an example embodiment of the present invention when viewed from the front lower side thereof.

FIG. 19 is a sectional perspective view of an engine according to an example embodiment of the present invention with an oil pan and an oblique portion horizontally sectioned.

FIG. 20 is a top view of a flying apparatus according to an example embodiment of the present invention.

FIG. 21 is a perspective view of a flying apparatus according to an example embodiment of the present invention.

FIG. 22 is a front view of a flying apparatus according to an example embodiment of the present invention.

FIG. 23 is a rear view of a flying apparatus according to an example embodiment of the present invention.

FIG. 24 is an enlarged rear view of a portion of a flying apparatus according to an example embodiment of the present invention.

FIG. 25 is an enlarged top view of a portion of a flying apparatus with an engine mounted therein according to an example embodiment of the present invention.

FIG. 26 is an enlarged right side view of a portion of a flying apparatus according to an example embodiment of the present invention.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Example embodiments of an engine 1 and a flying apparatus 101 which includes the engine 1 will now be described with reference to the accompanying drawings. For convenience, the following description refers to a direction indicated by an arrow F as “front” or “forward”, a direction indicated by an arrow B as “rear” or “rearward”, a direction indicated by an arrow Las “left” or “leftward”, and a direction indicated by an arrow R as “right” or “rightward”. A direction indicated by an arrow U is referred to as “up” or “upward”, and a direction indicated by an arrow D as “down” or “downward”.

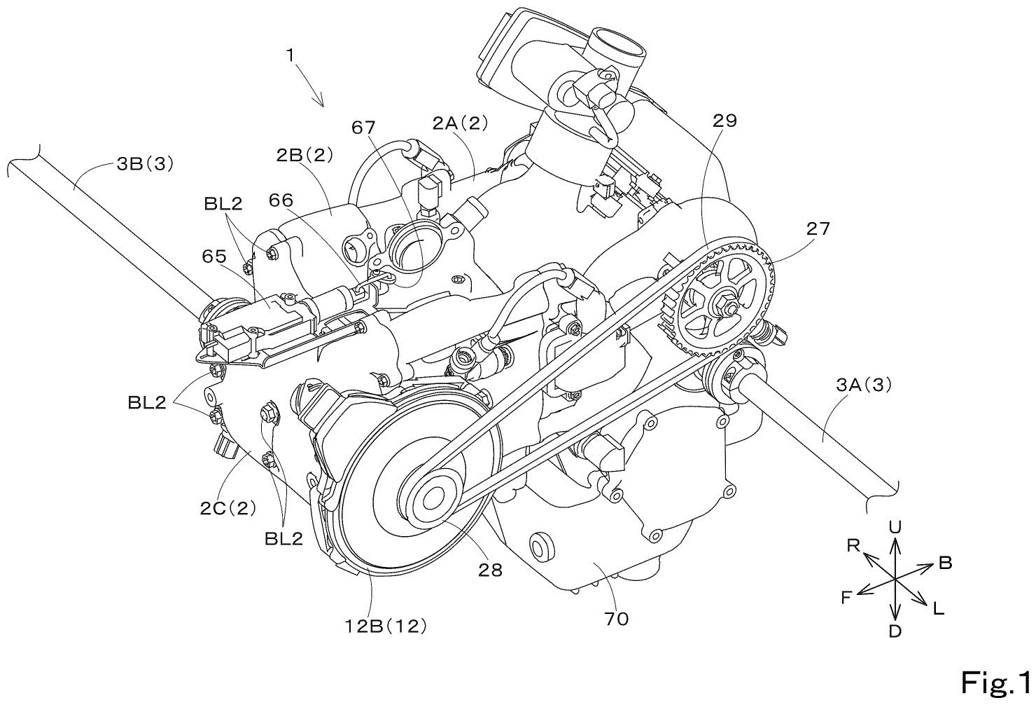

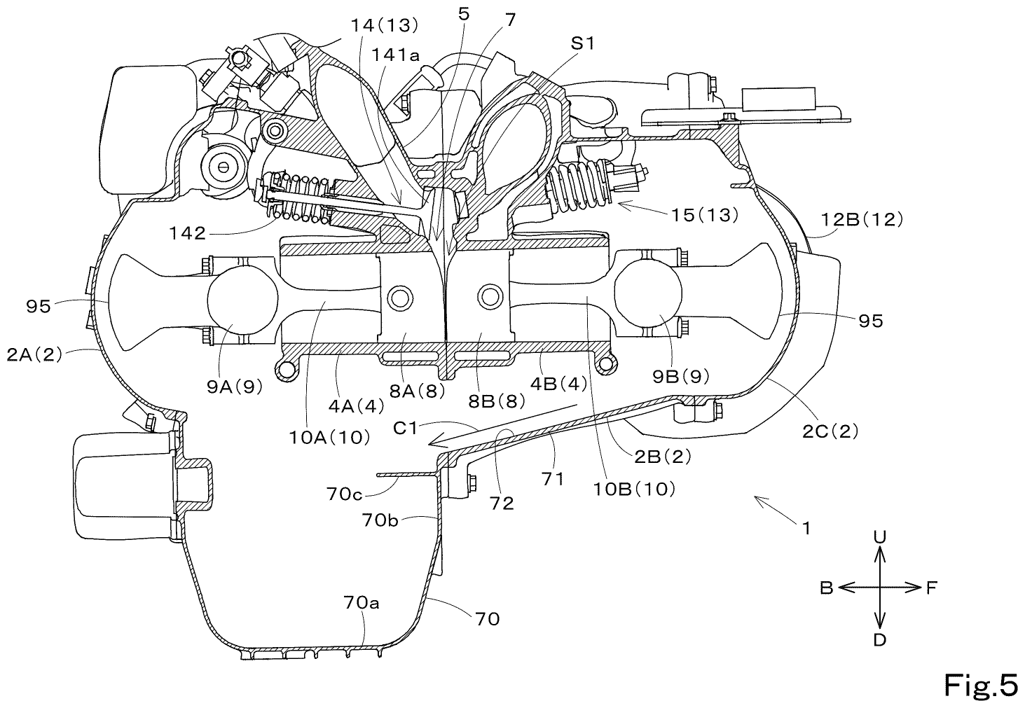

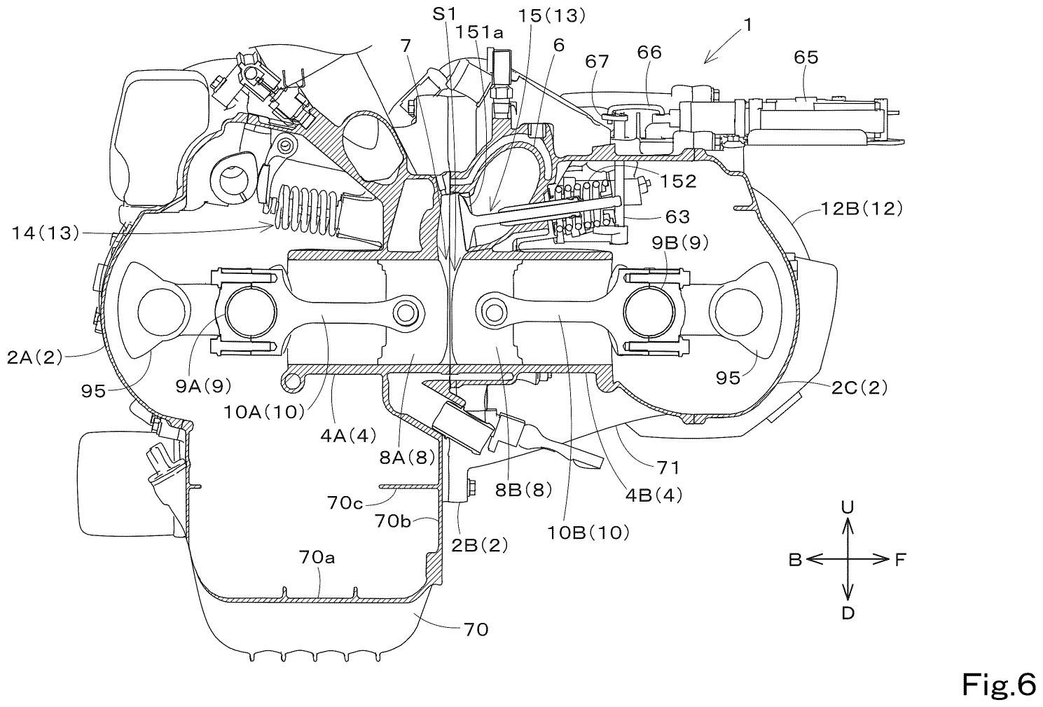

The engine 1 according to an example embodiment described below is an opposed-piston engine 1 including a cylinder in which two pistons are opposed to each other. As shown in FIGS. 1 to 4, the opposed-piston engine 1 includes an engine block 2, and output shafts 3 projecting from the engine block 2. As shown in FIGS. 5 and 6, the engine block 2 includes one or more cylinders 4, and one or more intake passages 5 and one or more exhaust passages 6 which communicate with the one or more cylinders 4.

As shown in FIGS. 1 to 3, the engine block 2 includes a plurality of blocks combined together. In the present example embodiment, the engine block 2 includes a first block 2A, a second block 2B and a third block 2C. The first block 2A is provided at a rear portion of the engine block 2. The third block 2C is provided at a front portion of the engine block 2. The second block 2B is provided between the first block 2A and the third block 2C. The first block 2A and the second block 2B are connected by bolts BL1. The second block 2B and the third block 2C are connected by bolts BL2. Thus, the engine block 2 can be divided into the plurality of blocks (the first block 2B, the second block 2B and the third block 2C) by removing the bolts BL1 and BL2.

As shown in FIGS. 5 and 6, in the engine block 2, the one or more cylinders 4 are axially extended in a horizontal direction (front-rear direction). The one or more cylinders 4 include one or more first cylinders 4A and one or more second cylinders 4B. The one or more first cylinders 4A are provided in the first block 2A. The one or more second cylinders 4B are provided in the second block 2B. Each of the one or more first cylinders 4A and a corresponding one of the one or more second cylinders 4B are aligned in the horizontal direction (front-rear direction). A front end of each of the one or more first cylinders 4A and a rear end of the corresponding one of the one or more second cylinders 4B abut (contact) each other. Each of the one or more first cylinders 4A and the corresponding one of the one or more second cylinders 4B are aligned coaxially to each other. An inside of each of the one or more first cylinders 4A and an inside of the corresponding one of the one or more second cylinders 4B communicate with each other.

As shown in FIGS. 5 and 6, each of the one or more first cylinders 4A and the corresponding one of the one or more second cylinders 4B include a boundary section defining a boundary therebetween, and an opening 7 is provided in an upper portion of the boundary section. Each of the one or more intake passages 5 and a corresponding one of the one or more exhaust passages 6 communicate with corresponding ones of the cylinders 4 via the corresponding opening 7. The one or more intake passages 5 are opened and closed via respective one or more intake valves 14. The one or more exhaust passages 6 are opened and closed via respective one or more exhaust valves 15.

The engine block 2 includes pistons 8 and crankshafts 9. The pistons 8 are each provided inside each of the cylinders 4. The pistons 8 include one or more first pistons 8A and one or more second pistons 8B. The one or more first pistons 8A are each provided inside a corresponding one of the one or more first cylinders 4A. The one or more second pistons 8B are each provided inside a corresponding one of the one or more second cylinders 4B. Each of the one or more first pistons 8A and a corresponding one of the one or more second pistons 8B are aligned in a horizontal direction (front-rear direction). Each of the one or more first pistons 8A and the corresponding one of the one or more second piston 8B are opposed to each other.

The one or more first pistons 8A reciprocate in the horizontal direction (front-rear direction) inside the respective one or more first cylinders 4A. The one or more second pistons 8B reciprocate in the horizontal direction (front-rear direction) inside the respective one or more second cylinders 4B. Each of the one or more first pistons 8A and each of the one or more second pistons 8B corresponding to each other move in opposite directions such that they move away from each other and approach each other. Hereinafter, combination of each of the one or more first pistons 8A and the corresponding one of the one or more second pistons 8B is referred to as a “pair of pistons”.

As shown in FIGS. 5 and 6, an upper portion (front upper portion) of a portion of each of the one or more first pistons 8A facing the corresponding one of the one or more second pistons 8B is curved in a direction away from the corresponding one of the one or more second pistons 8B. An upper portion (rear upper portion) of a portion of each of the one or more second pistons 8B facing the corresponding one of the one or more first pistons 8A is curved in a direction away from the corresponding one of the one or more first pistons 8A. Thus, when one of the one or more first pistons 8A and a corresponding one of the one or more second pistons 8B approach each other, a space S1 is created between the front upper portion of the one of the one or more first pistons 8A and the rear upper portion of the corresponding one of the one or more second pistons 8B. The space S1 communicates with the intake passage 5 and the exhaust passage 6 via the corresponding opening 7.

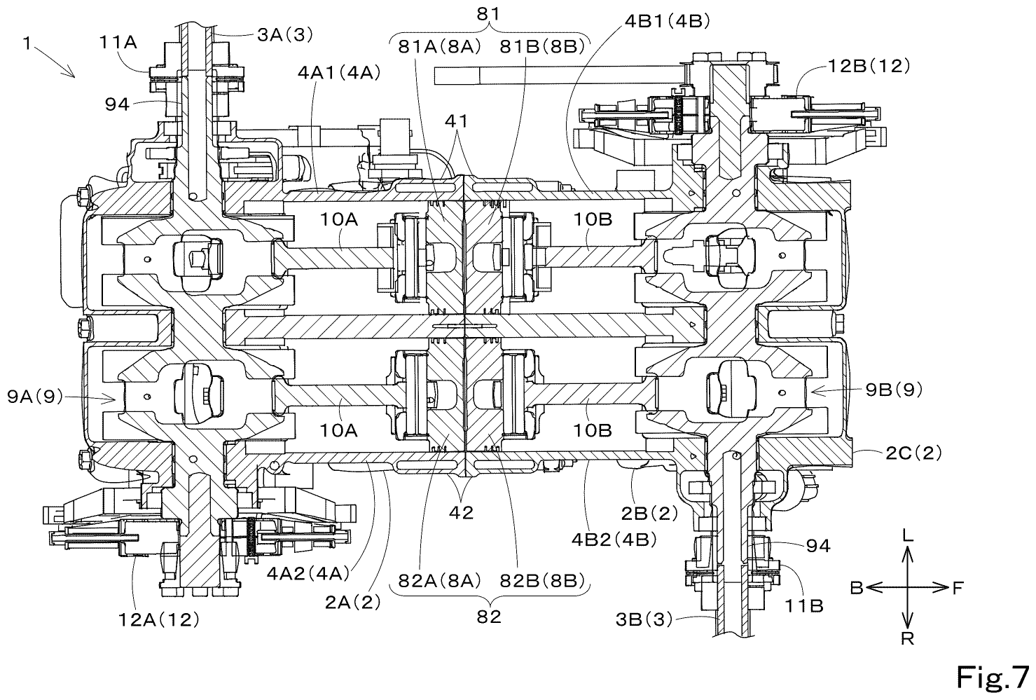

As shown in FIG. 7, the opposed-piston engine 1 includes two pairs of pistons, each pair of pistons including the first piston 8A and the second piston 8B. In the following, the two pairs of pistons are referred to as a first piston pair 81 and a second piston pair 82. The first piston pair 81 and the second piston pair 82 are arranged in a horizontal direction. Specifically, the first piston pair 81 and the second piston pair 82 are arranged in a left-right direction. More specifically, the first piston pair 81 is provided leftward, and the second piston pair 82 is provided rightward.

For convenience, the following description refers to the first piston 8A defining the first piston pair 81 as “first piston 81A”, and to the second piston 8B defining the second piston pair 82 as “second piston 81B”. The first piston 8A defining the second piston pair 82 is referred to as “first piston 82A”, and the second piston 8B defining the first piston 82A is referred to as “second piston 82B”.

That is, because the opposed-piston engine 1 of the present example embodiment includes two pair of pistons, the opposed-piston engine 1 of the present example embodiment includes four pistons (the first piston 81A, the second piston 81B, the first piston 82A, and the second piston 82B), for example. However, the number of pairs of pistons is not limited to two, and may be one or three or more. Accordingly, the number of pistons 8 is not limited to four, and may be two or six or more.

As shown in FIG. 7, the one or more first cylinders 4A include a first cylinder 4A1 which includes the first piston 81A and a first cylinder 4A2 which includes the first piston 82A. The one or more second cylinders 4B include a second cylinder 4B1 which includes a second piston 81B and a second cylinder 4B2 which includes a second piston 82B. Thus, the opposed-piston engine 1 includes four cylinders (the first cylinder 4A1, the second cylinder 4B1, the first cylinder 4A2 and the second cylinder 4B2) which contain the respective four pistons. That is, the opposed-piston engine 1 includes a four-cylinder engine. However, the number of cylinders 4 is set according to the number of pistons 8 and is not limited to four.

As shown in FIG. 7, a front end of the first cylinder 4A1 and a rear end of the second cylinder 4B1 abut (contact) each other. An inside of the first cylinder 4A1 and an inside of the second cylinder 4B1 communicate with each other. The following refers to combination of the first cylinder 4A1 and the second cylinder 4B1 as “first cylinder structure 41”. A front end of the first cylinder 4A2 and a rear end of the second cylinder 4B2 abut (contact) each other. An inside of the first cylinder 4A2 and an inside of the second cylinder 4B2 communicate with each other. The following refers to combination of the first cylinder 4A2 and the second cylinder 4B2 as “second cylinder structure 42”. The first cylinder structure 41 and the second cylinder structure 42 are arranged in the left-right direction.

As previously described, each of the intake passages 5 (see FIG. 5) and a corresponding one of the exhaust passages 6 (see FIG. 6) communicate with the inside or insides of the corresponding one or more cylinders 4. Although not illustrated in FIG. 7, the first cylinder structure 41 and the second cylinder structure 42 are each provided with the corresponding intake passage 5 and the corresponding exhaust passage 6.

The intake passages 5 include one or more first intake passages communicating with the inside of the first cylinder structure 41, and one or more second intake passages communicating with the inside of the second cylinder structure 42. Two first intake passages and two second intake passages are provided. That is, the first cylinder structure 41 includes the two first intake passages, and the second cylinder structure 42 includes the two second intake passages. The two first intake passages and the two second intake passages are provided with respective intake valves 14.

The exhaust passages 6 include one or more first exhaust passages communicating with the inside of the first cylinder structure 41, and one or more second exhaust passages communicating with the inside of the second cylinder structure 42. One first exhaust passage and one second exhaust passage are provided. The one first exhaust passage and the one second exhaust passage are provided with respective exhaust valves 15.

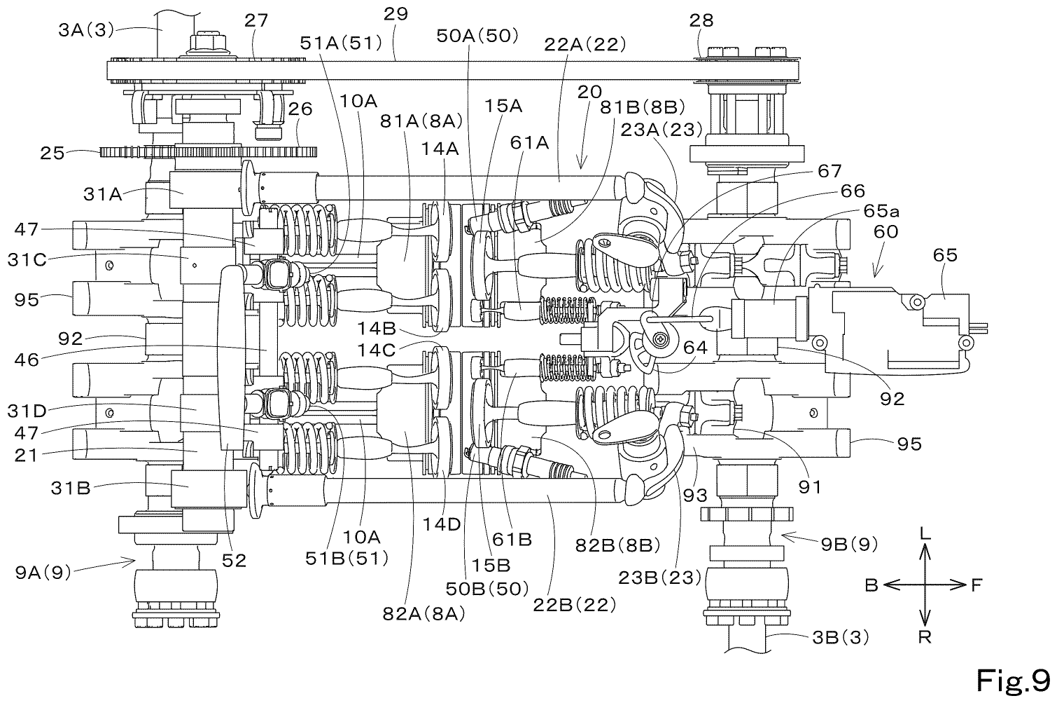

Thus, the opposed-piston engine 1 includes two intake valves 14 and one exhaust valve 15 for each of the cylinder structures. The opposed-piston engine 1 includes two cylinder structures (the first cylinder structure 41 and the second cylinder structure 42), so that the opposed-piston engine 1 includes four intake valves 14 (see reference numerals 14A, 14B, 14C and 14D in FIG. 9) and two exhaust valves 15 (see reference numerals 15A and 15B in FIG. 9), for example.

As shown in FIGS. 5 and 6, the crankshafts 9 are connected to the pistons 8 via respective connecting rods 10. As shown in FIGS. 8, 9 and 7, each of the crankshafts 9 includes crank pins 91, crank journals 92, crank arms 93, a main shaft 94, and counterweights 95. Each of the crank pins 91 is connected to a corresponding one of the connecting rods 10. The crank pins 91 and the crank journals 92 are connected via the crank arms 93. The main shaft 94 is connected to an output shaft 3.

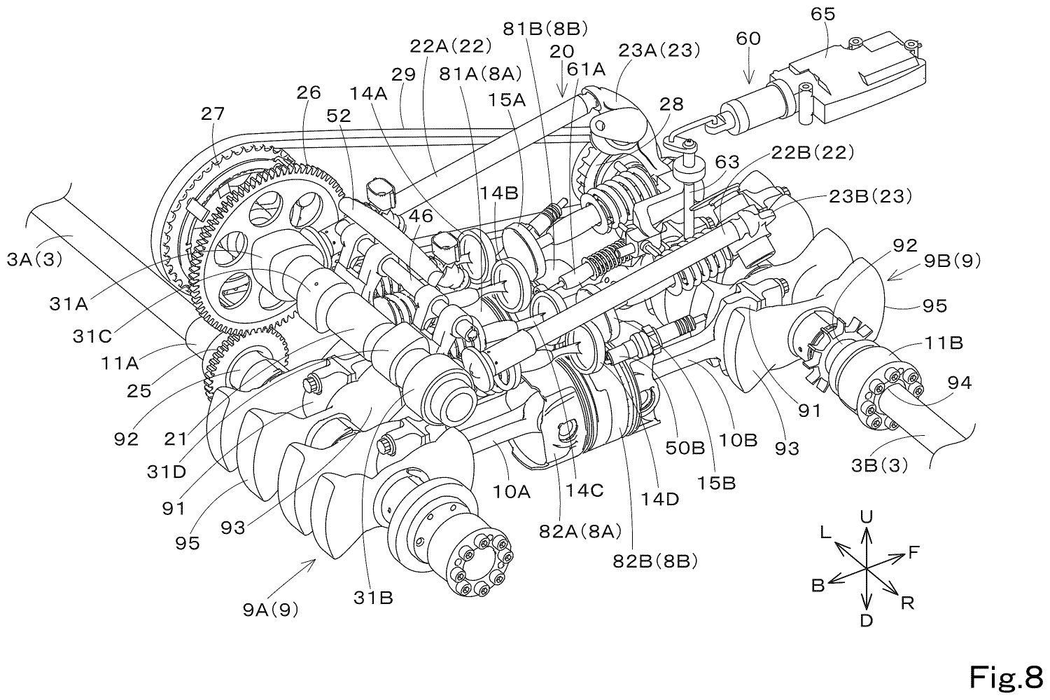

As shown in FIGS. 8 and 9, the crankshafts 9 include a first crankshaft 9A and a second crankshaft 9B. The first crankshaft 9A and the second crankshaft 9B are juxtaposed with a space therebetween in a first piston 8A and second piston 8B alignment direction in which each of the first pistons 6A and a corresponding one of the second pistons 6B are aligned. The first crankshaft 9A and the second crankshaft 9B extend parallel or substantially parallel to each other. The first crankshaft 9A and the second crankshaft 9B extend perpendicularly to the first piston 8A and second piston 8B alignment direction.

In the present example embodiment, the first piston 8A and second piston 8B alignment direction is the front-rear direction. Thus, the first crankshaft 9A and the second crankshaft 9B are juxtaposed with the space therebetween in the front-rear direction. The first crankshaft 9A and the second crankshaft 9B extend in the left-right direction. However, the front, rear, left and right directions for the opposed-piston engine 1 change depending on the orientation of the opposed-piston engine 1 when installed in or on something.

As shown in FIG. 7, the first crankshaft 9A is connected to the first pistons 8A via the respective first connection rods 10A. The second crankshaft 9B is connected to the second pistons 8B via the respective second connection rods 10B. The first crankshaft 9A rotates according to the reciprocating motions of the first pistons 8A. The second crankshaft 9B rotates according to the reciprocating motion of the second pistons 8B.

A rotational power of each of the crankshafts 9 is outputted from the corresponding output shaft 3 connected to the corresponding main shaft 94. The output shafts 3 include a first output shaft 3A and a second output shaft 3B. The first output shaft 3A and the second output shaft 3B are parallel or substantially parallel to each other. The first output shaft 3A and the second output shaft 3B extend away from each other in opposite directions.

As shown in FIG. 7, the first output shaft 3A is connected to the main shaft 94 of the first crankshaft 9A via a first coupling 11A. The second output shaft 3B is connected to the main shaft 94 of the second crankshaft 9B via a second coupling 11B. Accordingly, the rotational power of the first crankshaft 9A is outputted from the first output shaft 3A, and the rotational power of the second crankshaft 9B is outputted from the second output shaft 3B.

As shown in FIGS. 1, 2 and 7, the opposed-piston engine 1 includes generators 12. The generators 12 include a first generator 12A and a second generator 12B. The first generator 12A is attached to the first crankshaft 9A, and the second generator 12B is attached to the second crankshaft 9B. More specifically, the first generator 12A is attached to an end of the first crankshaft 9A opposite to the first output shaft 3A. The second generator 12B is attached to an end of the second crankshaft 9B opposite to the second output shaft 3B. As the first crankshaft 9A rotates, the first generator 12A is driven to generate electricity. As the second crankshaft 9B rotates, the second generator 12B is driven to generate electricity.

As shown in FIGS. 5 and 6, the opposed-piston engine 1 includes valves 13 each to perform an operation to intake or exhaust air. The valves 13 are each operable to perform the operation to intake or exhaust air into and from a corresponding one of the cylinders 4. The valves 13 include the previously mentioned intake valves 14 and exhaust valves 15. The intake valves 14 are provided in the respective intake passages 5 which communicate with the insides of the respective cylinders 4. The exhaust valves 15 are provided in the respective exhaust passages 6 which communicate with the insides of the respective cylinders 4. The intake valves 14 are provided on the same side as the first crankshaft 9A to be closer to the first crankshaft 9A than to the second crankshaft 9B. The exhaust valves 15 are provided on the same side as the second crankshaft 9B to be closer to the second crankshaft 9B than to the first crankshaft 9A. However, the intake valves 14 may be provided on the same side as the second crankshaft 9B to be closer to the second crankshaft 9B than to the first crankshaft 9A, and the exhaust valves 15 may be provided on the same side as the first crankshaft 9A to be closer to the first crankshaft 9A than to the second crankshaft 9B.

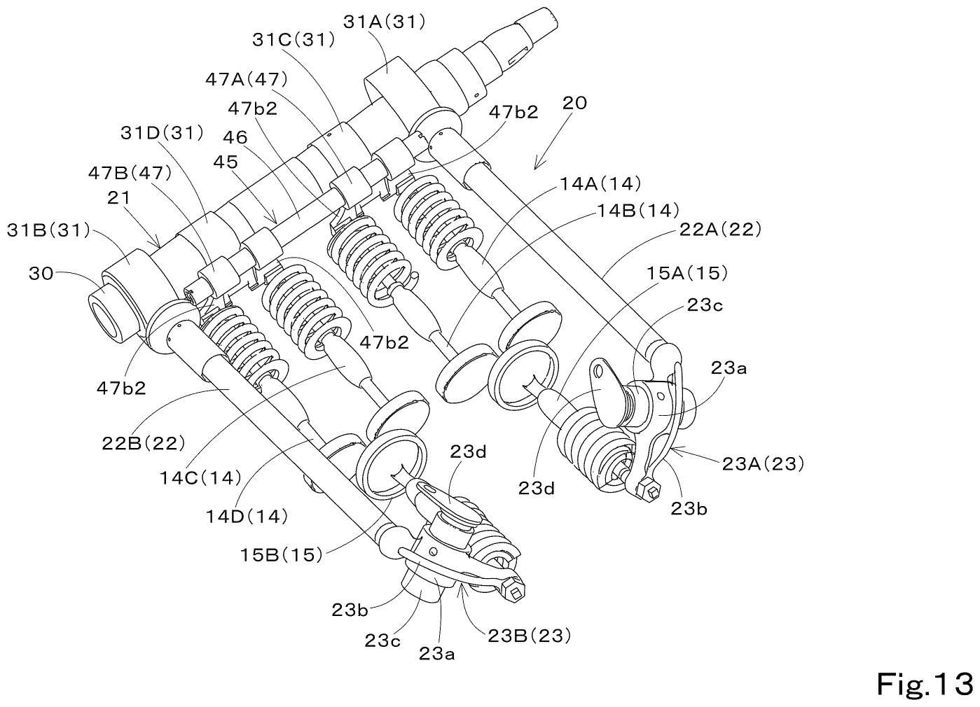

As shown in FIGS. 8 and 9, the opposed-piston engine 1 includes a power transmission 20 to transmit the rotational power of the first crankshaft 9A to the valves 13 so as to operate the valves 13. FIG. 13 illustrates a configuration of the power transmission 20. The power transmission 20 transmits the rotational power of the first crankshaft 9A to the exhaust valves 15 and the intake valves 14 to cause the exhaust valves 15 and the intake valves 14 to perform respective operations.

As shown in FIGS. 13, 8 and 9, the power transmission 20 includes a camshaft 21, pushrods 22, and rocker arms 23. The camshaft 21 includes only a single camshaft provided on the same side as the first crankshaft 9A (on the rear side) in the first piston 8A and second piston 8B alignment direction (front-rear direction). That is, there is the camshaft 21 on the same side as the first crankshaft 9A, and there is no camshaft on the same side as the second crankshaft 9B. The camshaft 21 extends parallel or substantially parallel to the first crankshaft 9A. The camshaft 21 is provided at a position above the first crankshaft 9A.

Note that the camshaft 21 may be provided at a position different from the position above the first crankshaft 9A (for example, forward or rearward from the position above the first crankshaft 9A). The camshaft 21 may be provided on the same side as the second crankshaft 9B and there may be no camshaft on the same side as the first crankshaft 9A. In such a case, the camshaft 21 is provided, for example, at a position above the second crankshaft 9B.

As shown in FIGS. 8 and 9, a first gear 25 is mounted on the first crankshaft 9A. A second gear 26 is mounted on the camshaft 21. The first gear 25 meshes with the second gear 26. When the first gear 25 rotates according to the rotation of the first crankshaft 9A, the camshaft 21 rotates together with the second gear 26 which meshes with the first gear 25. Thus, the camshaft 21 rotates as the first crankshaft 9A rotates. The rotation direction of the camshaft 21 is opposite to the rotation direction of the first crankshaft 9A.

As shown in FIGS. 1, 8 and 9, a third gear 27 is mounted on the camshaft 21. A fourth gear 28 is mounted on the second crankshaft 9B. An endless (looped) belt is looped over the third gear 27 and the fourth gear 28. Accordingly, a rotation of the camshaft 21 is transmitted to the second crankshaft 9B. The rotation direction of the second crankshaft 9B is the same as the rotation direction of the camshaft 21. The rotation direction of the first crankshaft 9A is opposite to the rotation direction of the camshaft 21. Thus, the rotation direction of the first crankshaft 9A is opposite to the rotation direction of the second crankshaft 9B so that the first output shaft 3A and the second output shaft 3B rotate in opposite directions.

As shown in FIG. 13, the camshaft 21 includes a shaft 30 and at least one cam 31 which is provided on the shaft 30. A plurality of the cams 31 are arranged at intervals in a longitudinal direction of the shaft 30 (left-right direction). The plurality of cams 31 include a first cam 31A, a second cam 31B, a third cam 31C and a fourth cam 31D (see FIG. 8). The four cams (the first cam 31A, the second cam 31B, the third cam 31C and the fourth cam 31D) are spaced from each other in the extending direction of the camshaft 21.

The first cam 31A and the second cam 31B are separated from each other by a distance and provided at respective positions close to both ends of the camshaft 21. The first cam 31A is provided at the position close to one end (left portion) of the shaft 30, and the second cam 31B is provided at the position close to another end (right portion) of the shaft 30. The third cam 31C and the fourth cam 31D are provided between the first cam 31A and the second cam 31B. The third cam 31C is adjacent to the first cam 31A. The fourth cam 31D is adjacent to the second cam 31B.

The first cam 31A and the second cam 31B are offset in phase from each other by 180 degrees around an axial center of the shaft 30. The third cam 31C and the fourth cam 31D are offset in phase from each other by 180 degrees around the axial center of the shaft 30. The third cam 31C and the first cam 31A are offset in phase from each other by 90 degrees around the axial center of the shaft 30. The fourth cam 4D and the second cam 31B are offset in phase from each other by 90 degrees around the axial center of the shaft 30.

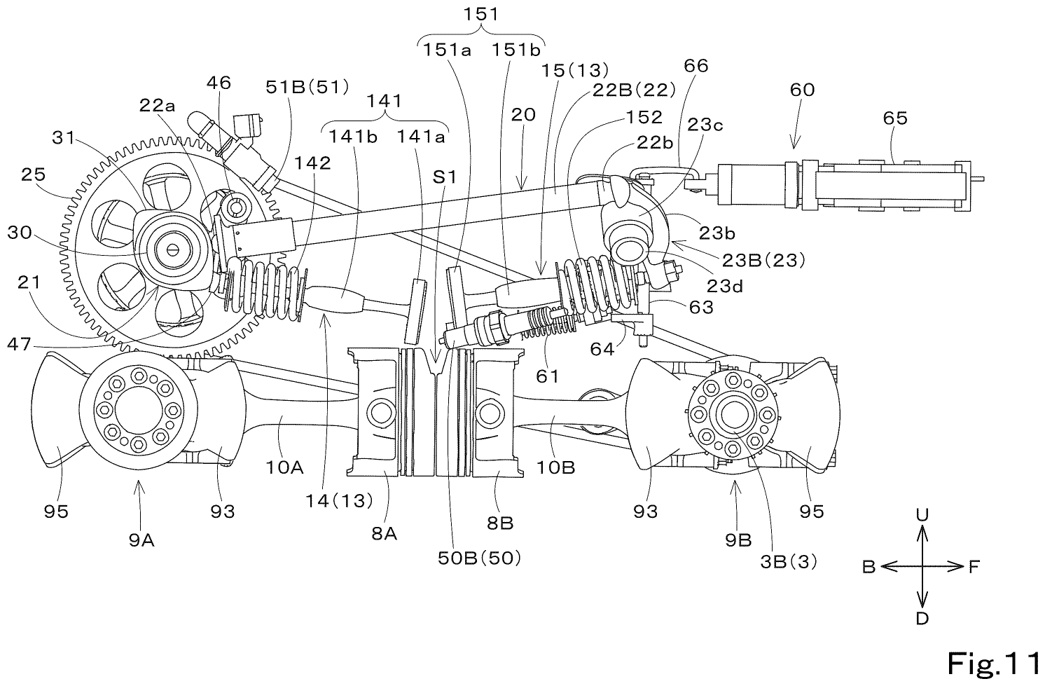

As shown in FIGS. 8, 9, 11 and 12, the pushrods 22 extend from respective positions corresponding to the first crankshaft 9A to respective positions corresponding to the second crankshaft 9B. A first end 22a (see FIG. 11) of each of the pushrods 22 is provided on the same side as the first crankshaft 9A (rearward). A second end 22b (see FIG. 11) of each of the pushrods 22 is provided on the same side as the second crankshaft 9B (forward). The first end 22a of each of the pushrods 22 abuts a corresponding one of the cams 31 (first cam 31A or second cam 31B). The second end 22b of each of the pushrods 22 is connected to a corresponding one of the rocker arms 23.

As shown in FIGS. 8 to 10 and the like, the pushrods 22 include a first pushrod 22A and a second pushrod 22B. The first pushrod 22A and the second pushrod 22B are spaced from each other in the extending direction (left right direction) of the camshaft 21. The first pushrod 22A and the second pushrod 22B are provided parallel or substantially parallel to each other. The first pushrod 22A extends in the front-rear direction at a position toward one end (left portion) of the camshaft 21. The second pushrod 22B extends in the front-rear direction at position toward another end (right portion) of the camshaft 21.

A first end of the first pushrod 22A abuts the first cam 31A. A first end of the second pushrod 22B abuts the second cam 31B. The first cam 31A and the second cam 31B rotate together with the camshaft 21. As the first cam 31A rotates together with the camshaft 21, the first pushrod 22A reciprocates. As the second cam 31B rotates together with the camshaft 21, the second pushrod 22B reciprocates. Thus, the pushrods 22 (the first pushrod 22A and the second pushrod 22B) reciprocate according to rotation of the single camshaft 21.

The rocker arms 23 each connect a corresponding one of the pushrods 22 to a corresponding one of the valves 13. More specifically, the rocker arms 23 each connect the second end 22b of the corresponding one of the pushrods 22 to the corresponding one of the valves 13 on the same side as the second crankshaft 9B (see FIG. 11). The rocker arms 23 each connect the second end 22b of the corresponding one of the pushrods 22 to a corresponding one of the intake valves 14 or of the exhaust valves 15. In the present example embodiment, the rocker arms 23 connect the second ends 22b of the respective pushrods 22 to the respective exhaust valves 15.

In an alternative example embodiment, the intake valves 14 may be provided on the same side as the second crankshaft 9B, and the rocker arms 23 may connect the second ends 22b of the respective pushrods 22 to the respective intake valves 14. In such a case, the exhaust valves 15 are provided on the same side as the first crankshaft 9A.

As shown in FIGS. 8, 9 and 13, the rocker arms 23 include a first rocker arm 23A and a second rocker arm 23B. The first rocker arm 23A is operably connected to the first pushrod 22A. The second rocker arm 23B is operably connected to the second pushrod 22B. More specifically, the first rocker arm 23A operably connects the second end of the first pushrod 22A to a corresponding one of the exhaust valves 15 (a first exhaust valve 15A as described later). The second rocker arm 23B operably connects the second end of the second pushrod 22B to a corresponding one of the exhaust valves 15 (a second exhaust valve 15B as described later).

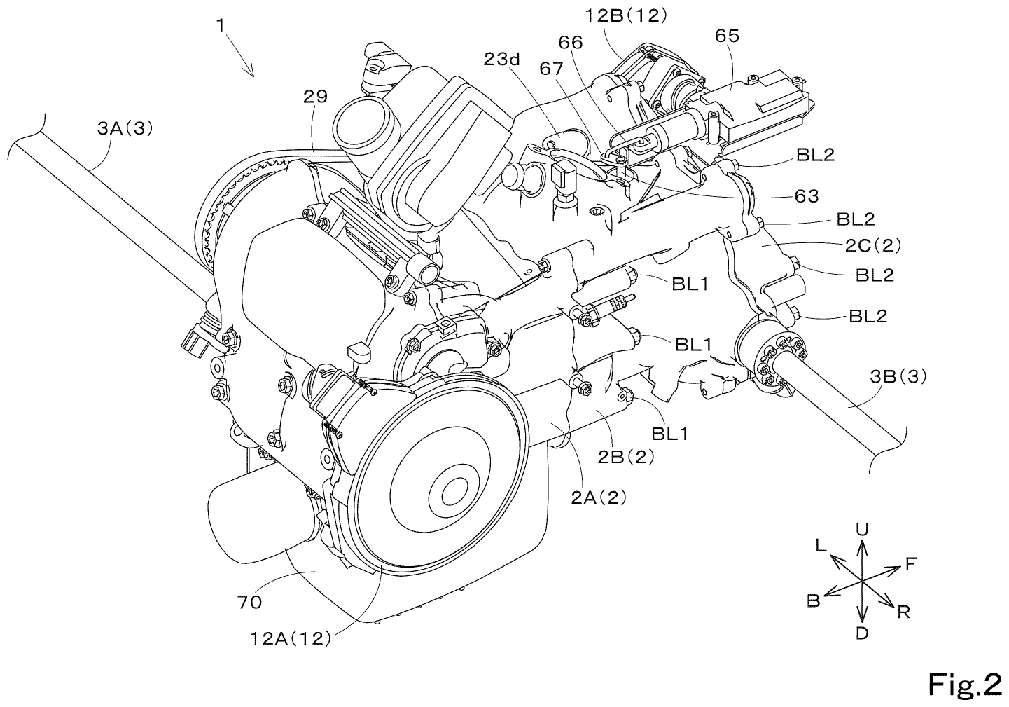

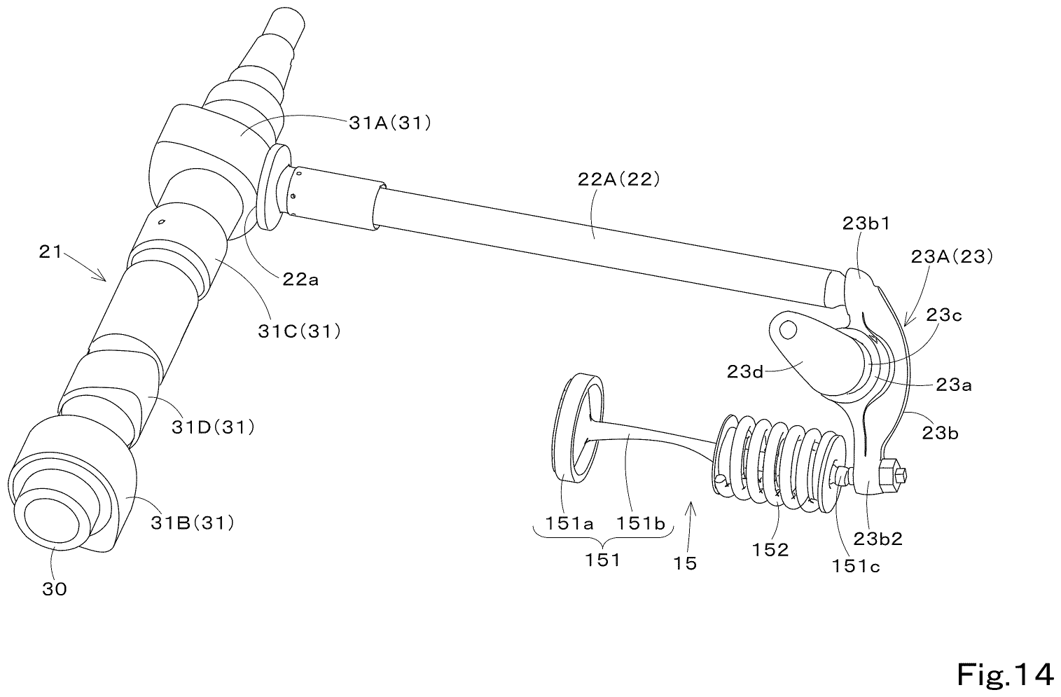

As shown in FIGS. 13 and 14, the rocker arms 23 each include a tubular portion 23a and a curved portion 23b. The tubular portion 23a has an axial body 23c inserted therein. A fixture plate 23d is attached to an end of the axial body 23c. As shown in FIG. 2, the fixture plate 23d is fixed to the engine block 2. Accordingly, the axial body 23c is positioned on the engine block 2 and supported by the engine block 2.

As shown in FIG. 14, the curved portion 23b includes a first portion 23b1 and a second portion 23b2. The first portion 23b1 and the second portion 23b2 are opposed to each other with the tubular portion 23a therebetween. The curved portion 23b rocks using the axial body 23c as a fulcrum as the corresponding one of the pushrods 22 reciprocates. When the curved portion 23b rocks, the first portion 23b1 and the second portion 23b2 rotate in opposite directions with the tubular portion 23a therebetween as a fulcrum.

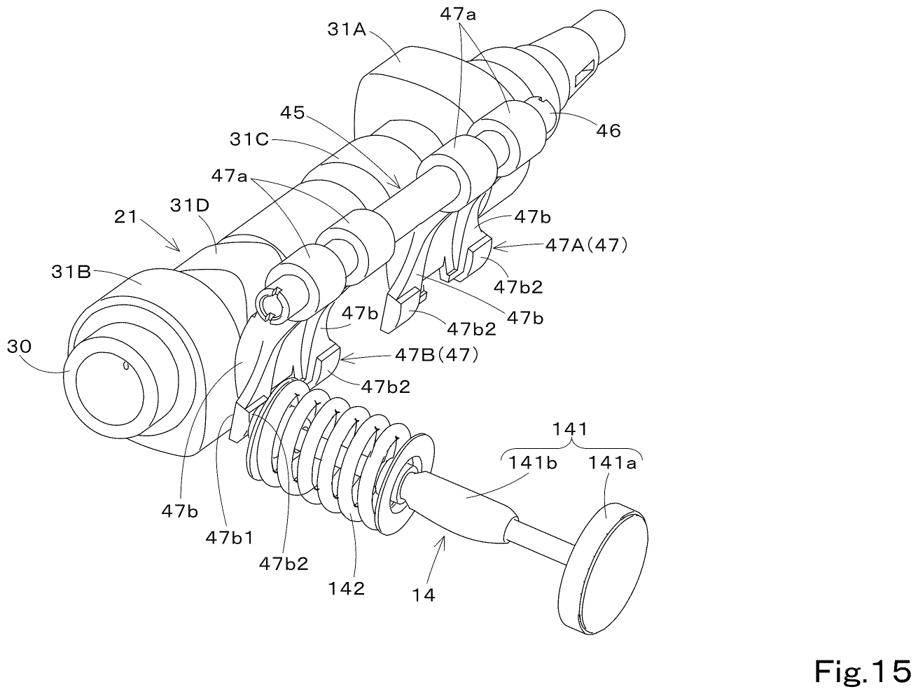

The first portion 23b1 of the curved portion 23b is connected to the second end 22b of the corresponding one of the pushrods 22. The second portion 23b2 abuts a proximal end of a first valve that is a corresponding one of the intake valves 14 or of the exhaust valves 15. In the present example embodiment, the first valve is one of the exhaust valves 15, and a second valve other than the first valve is one of the intake valves 14. Thus, in the present example embodiment, the second portion 23b2 of the curved portion 23b of each of the rocker arms 23 abuts a proximal end 151c of the corresponding one of the exhaust valves 15. Thus, the proximal end 151c of the exhaust valve 15 as the first valve which is one of the intake valve 14 or the exhaust valve 15 abuts a corresponding one of the rocker arms 23. On the other hand, as shown in FIGS. 13 and 15, a proximal end of the intake valve 14 as the second valve which is the other of the intake valve 14 or the exhaust valve 15 abuts a rocker 47 (later described) which is interlocked with a corresponding one of the cams 31. Of the cams 31, the third cam 31C and the fourth cam 31D are interlocked with the respective rockers 47.

As shown in FIGS. 13, 15 and the like, a link mechanism 45 includes a pivot shaft 46 and the rockers 47. As shown in FIG. 9, the pivot shaft 46 extends in parallel or substantially parallel to the camshaft 21 and the crankshafts 9. The pivot shaft 46 is supported by the engine block 2. The pivot shaft 46 is provided on the same side as the first crankshaft 9A (rearward) in the first piston 8A and second piston 8B alignment direction (front-rear direction). As shown in FIG. 11, the pivot shaft 46 is located above the first crankshaft 9A and in the vicinity of the camshaft 21.

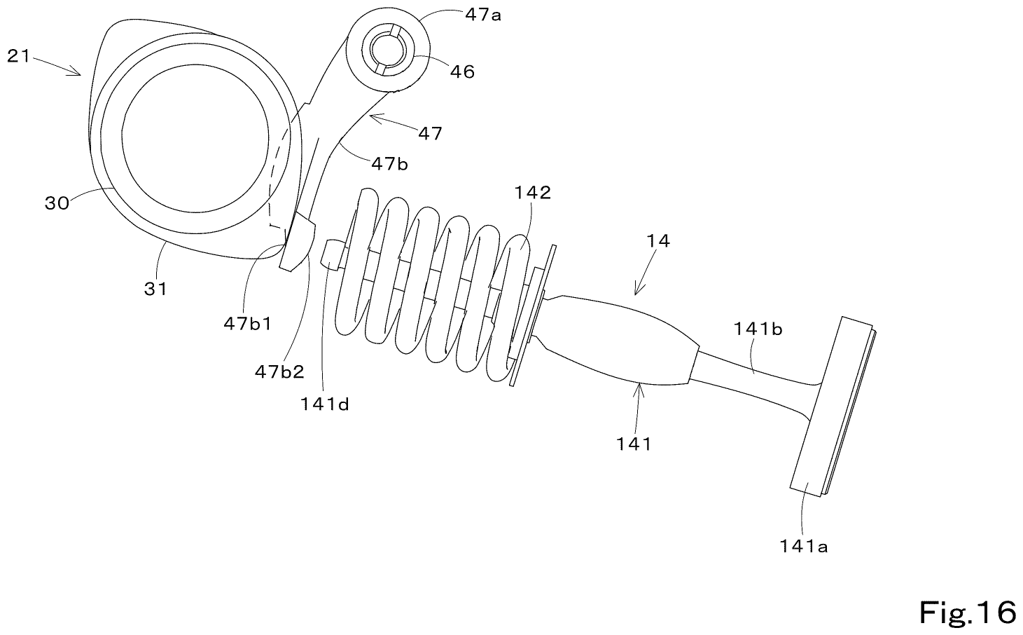

As shown in FIG. 15, the rockers 47 are mounted to the pivot shaft 46. The rockers 47 are rockable about an axial center of the pivot shaft 46. As shown in FIGS. 15 and 16, the rockers 47 include tubular portions 47a and curved portions 47b, respectively. The pivot shaft 46 is passed through the tubular portions 47a. The curved portions 47b extend arcuately downward from the respective tubular portions 47a. The curved portions 47b each include a first abutting portion 47b1 which abuts a corresponding one of the cams 31, and a second abutting portion 47b2 which abuts a corresponding one of stems 141b (described later) of the intake valves 14.

As shown in FIG. 15, the rockers 47 include a first rocker 47A and a second rocker 47B. The first rocker 47A and the second rocker 47B have the same shape. The first rocker 47A includes two tubular portions 47a and two curved portions 47b. Thus, the first rocker 47A includes two first abutting portions 47b1 and two second abutting portions 47b2. The second rocker 47B includes two tubular portions 47a and two curved portions 47b. Thus, the second rocker 47B includes two first abutting portions 47b1 and two second abutting portions 47b2.

As shown in FIGS. 11, 15 and 16, the intake valves 14 each include a valve main body 141 which includes a valve head 141a and the stem 141b, and a spring 142 which biases the valve main body 141. The valve head 141a is provided on a distal end of the stem 141b (distal end of the intake valve 14). The second abutting portion 47b2 of the corresponding rocker 47 is allowed to abut a proximal end of the stem 141b. The spring 142 biases the valve main body 141 in a direction to close the corresponding intake valve 14 (direction to close the corresponding intake passage 5).

As shown in FIGS. 11 and 14, the exhaust valves 15 each include a valve main body 151 which includes a valve head 151a and a stem 151b, and a spring 152 which biases the valve main body 151. The valve head 151a is provided on a distal end of the stem 151b (distal end of the exhaust valve 15). The spring 152 biases the valve main body 151 in a direction to close the corresponding exhaust valve 15 (direction to close the corresponding exhaust passage 6).

The intake valves 14 and the exhaust valves 15 operate according to rotation of the single camshaft 21. The following describes operations of the intake valves 14 and the exhaust valves 15 according to rotation of the single camshaft 21.

As shown in FIG. 16, a proximal end of each of the intake valves 14 (a proximal end 141d of the stem 141b) is provided at a position where it is allowed to, when a corresponding one of the rockers 47 rotates, abut a corresponding one of the second abutting portions 47b2 of the rocker 47. The corresponding cam 31 (the third cam 31C or the fourth cam 31D) on the camshaft 21 is allowed to, when rotating, abut the first abutting portion 47b1 of the rocker 47. Thus, the proximal ends of the intake valves 14 (proximal ends of the stems 141b) are allowed to abut the corresponding cam 31 (the third cam 31C or the fourth cam 31D) via the corresponding rocker 47.

When the cams 31 rotate together with the camshaft 21, one of the cams 31 abuts the corresponding first abutting portion 47b1, and pushes the first abutting portion 47b 1 toward the corresponding intake valves 14. Thus, the corresponding rocker 47 rocks toward the intake valves 14 using the pivot shaft 46 as a fulcrum, and the second abutting portions 47b2 of the rocker 47 push the proximal ends 141d of the corresponding stems 141b. When the stems 141b are pushed, the respective springs 142 are compressed to move the respective valve main bodies 141. Accordingly, the respective valve heads 141a which have closed the respective intake passages 5 (see FIG. 5) moves so that the respective intake valves 14 are opened (open the respective intake passages 5).

As shown in FIG. 14, the proximal end of each of the exhaust valves 15 (the proximal end 151c of the stem 151b) abuts the corresponding rocker arm 23. The first end 22a of the pushrod 22 abuts a corresponding one of the cams 31 (the first cam 31A or the second cam 31B). Thus, when the cams 31 rotate together with the camshaft 21, the first end 22a of one of the pushrods 22 abutting the corresponding cam 31 is pushed by the corresponding cam 31. Accordingly, the pushrod 22 moves toward the second crankshaft 9B (rightward of FIG. 14). Then, the curved portion 23b of the corresponding rocker arm 23 rocks with the axial body 23c as a fulcrum, and the proximal end 151c of the corresponding stem 151b which abuts the second portion 23b2 is pushed by the second portion 23b2. When the stem 151b is pushed, the spring 152 is compressed to move the valve main body 151. Accordingly, the valve head 151a which has closed the corresponding exhaust passage 6 moves so that the corresponding exhaust valve 15 is opened (open the corresponding exhaust passage 6).

As shown in FIGS. 9, 13 and the like, the exhaust valves 15 include a first exhaust valve 15A and a second exhaust valve 15B. The first exhaust valve 15A and the second exhaust valve 15B are spaced from each other in the extending direction of the camshaft 21. The exhaust valves 15 (the first exhaust valve 15A and the exhaust valve 15B) are arranged along the extending direction of the camshaft 21 between the first pushrod 22A and the second pushrod 22B. The first exhaust valve 15A is located on the same side as the first pushrod 22A. The second exhaust valve 15B is located on the same side as the second pushrod 22B.

As shown in FIGS. 9, 13 and the like, the intake valves 14 include a first intake valve 14A, a second intake valve 14B, a third intake valve 14C and a fourth intake valve 14D. The first intake valve 14A, the second intake valve 14B, the third intake valve 14C and the fourth intake valve 14D are arranged at intervals in the extending direction of the camshaft 21.

As shown in FIGS. 9, 13 and the like, the intake valves 14 (the first intake valve 14A, the second intake valve 14B, the third intake valve 14C and the fourth intake valve 14D) are located between the first pushrod 22A and the second pushrod 22B in the extending direction of the camshaft 21. The first intake valve 14A and the second intake valve 14B are located closer to the first pushrod 22A. The third intake valve 14C and the fourth intake valve 14D are located closer to the second pushrod 22B.

As shown in FIG. 9 and the like, the first intake valve 14A, the second intake valve 14B, the third intake valve 14C and the fourth intake valve 14D are aligned in this order from the first pushrod 22A side to the second pushrod 22B side. The first intake valve 14A and the second intake valve 14B are opposed to the first exhaust valve 15A. The third intake valve 14C and the fourth intake valve 14D are opposed to the second exhaust valve 15B.

As previously described, the intake valves 14 abut the rockers 47 (see FIG. 15 and the like). More specifically, two of the four intake valves 14 abut the first rocker 47A, and the remaining two intake valves 14 abut the second rocker 47B. More specifically, as shown in FIG. 13, the first intake valve 14A and the second intake valve 14B abut the respective second abutting portions 47b2 of the first rocker 47A. The third intake valve 14C and the fourth intake valve 14D abut the respective second abutting portions 47b2 of the second rocker 47B.

The first intake valve 14A abuts one of the second abutting portions 47b2 of the first rocker 47A. The second intake valve 14B abuts the other of the second abutting portions 47b2 of the first rocker 47A. Thus, the first intake valve 14A and the second intake valve 14B operate simultaneously as the common first rocker 47A rocks.

The third intake valve 14C abuts one of the second abutting portions 47b2 of the second rocker 47B. The fourth intake valve 14D abuts the other of the second abutting portions 47b2 of the second rocker 47B. Thus, the third intake valve 14C and the fourth intake valve 14D operate simultaneously as the common second rocker 47B rocks.

The first intake valve 14A and the second intake valve 14B are respectively provided in the two first intake passages which communicate with the inside of the first cylinder structure 41 as mentioned above. The third intake valve 14C and the fourth intake valve 14D are respectively provided in the two second intake passages which communicate with the inside of the second cylinder structure 42 as mentioned above.

The first exhaust valve 15A is provided in the first exhaust passage which communicates with the inside of the first cylinder structure 41 as mentioned above. The second exhaust valve 15B is provided in the second exhaust passage which communicates with the inside of the second cylinder structure 42 as mentioned above.

Thus, the opposed-piston engine 1 includes the cylinder structures each of which is provided with two intake valves 14 and one exhaust valve 15. More specifically, the first cylinder structure 41 is provided with two intake valves (the first intake valve 14A and the second intake valve 14B) and one exhaust valve (the first exhaust valve 15A). The second cylinder structure 42 is provided with two intake valves (the third intake valve 14C and the fourth intake valve 14D) and one exhaust valve (the second exhaust valve 15B).

In the previously mentioned example embodiment, the intake valves 14 are the first valves and the exhaust valves 15 are the second valves different from the first valves. Alternatively, the intake valves 14 may be the second valves and the exhaust valves 15 may be the first valves different from the second valves. In such a case, proximal ends of the exhaust valves 15 are allowed to abut the respective second abutting portions 47b2 of the rockers 47, so that the exhaust valves 15 are operably connected with the rockers 47. Proximal ends of the intake valves 14 abut the rocker arms 23 so that the intake valves 14 are operably connected with the rocker arms 23.

As shown in FIGS. 9, 11 and 12, the power transmission 20 extends in the first piston 8A and second piston 8B alignment direction to a position corresponding to the first crankshaft 9A and to a position corresponding to the second crankshaft 9B across the space therebetween. In other words, the power transmission 20 overlaps the first crankshaft 9A and the second crankshaft 9B at the respective positions in the first piston 8A and second piston 8B alignment direction. Specifically, the power transmission 20 overlaps the first crankshaft 9A at one end (front end) thereof in the first piston 8A and second piston 8B alignment direction (front-rear direction). The power transmission 20 overlaps the second crankshaft 9B at another end (rear end) thereof in the first piston 8A and second piston 8B alignment direction (front-rear direction).

More specifically, the rocker arms 23 of the power transmission 20 overlap the second crankshaft 9B at positions thereof in the first piston 8A and second piston 8B alignment direction. The camshaft 21 of the power transmission 20 overlaps the first crankshaft 9A at a position thereof in the first piston 8A and second piston 8B alignment direction. The first ends 22a (front ends) of the pushrods 22 of the power transmission 20 overlap the first crankshaft 9A at positions thereof in the first piston 8A and second piston 8B alignment direction. The second ends 22b (rear ends) of the pushrods 22 of the power transmission 20 overlap the second crankshaft 9B in the first piston 8A and second piston 8B alignment direction.

As shown in FIGS. 8, 9, 11 and 12, when one of the first pistons 8A and a corresponding one of the second pistons 8B are at their closest approach to each other, the power transmission 20 overlaps, in the first piston 8A and second piston 8B alignment direction, corresponding ones of the crank arms 93 and a corresponding one of the crank pins 91 of the first crankshaft 9A, and corresponding ones of the crank arms 93 and a corresponding one of the crank pins 91 of the second crankshaft 9B.

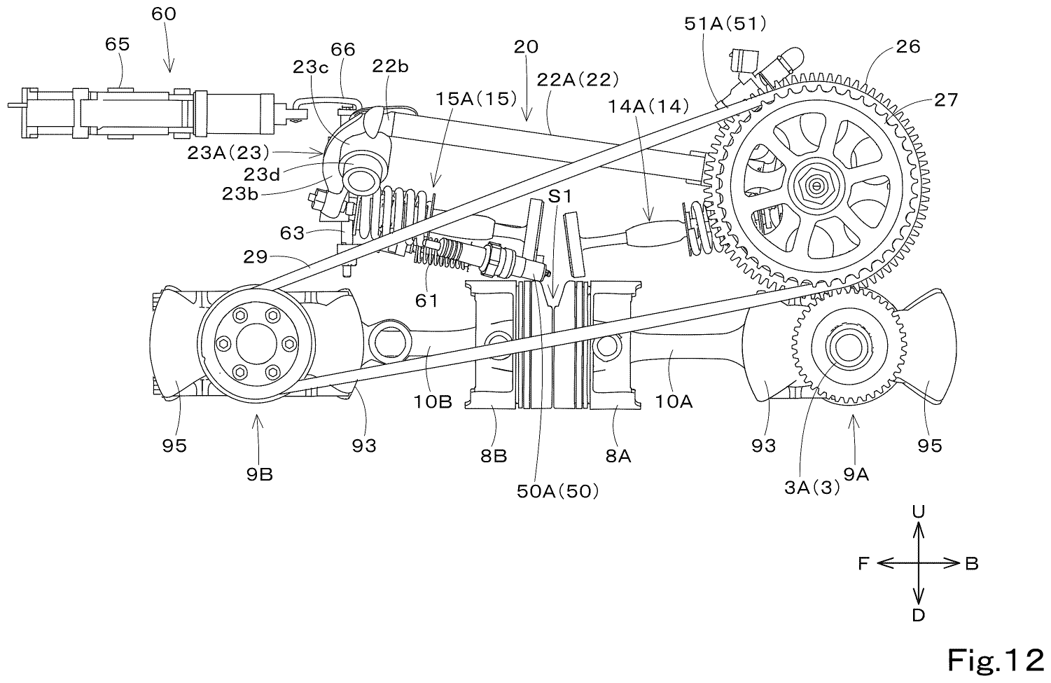

As shown in FIGS. 9, 11 and 12, the opposed-piston engine 1 includes spark plugs 50. The spark plugs 50 are each located in a vicinity of the space S1 (see FIGS. 11 and 12) between the front upper portion of a corresponding one of the first pistons 8A and the rear upper portion of a corresponding one of the second pistons 8B when the corresponding first piston 8A and the corresponding second piston 8B approach each other. The spark plugs 50 include a first spark plug 50A and a second spark plug 50B. The first spark plug 50A is provided at a position corresponding to the first piston pair 81 (see FIG. 7). The second spark plug 50B is provided at a position corresponding to the second piston pair 82 (see FIG. 7).

As shown in FIGS. 9 to 12, the opposed-piston engine 1 includes injection nozzles 51. The injection nozzles 51 are located above the first crankshaft 9A. The injection nozzles 51 each injects fuel toward the space S1 (see FIGS. 11 and 12) between the front upper portion of a corresponding one of the first pistons 8A and the rear upper portion of a corresponding one of the second pistons 8B when the corresponding first piston 8A and the corresponding second piston 8B approach each other. The injection nozzles 51 include a first injection nozzle 51A and a second injection nozzle 51B. The first injection nozzle 51A is provided to correspond to the first piston pair 81. The second injection nozzle 51B is provided to correspond to the second piston pair 82. The first injection nozzle 51A and the second injection nozzle 51B are connected to each other via a coupler 52.

The opposed-piston engine 1 is a four-cycle engine that repeatedly performs an intake cycle, a compression cycle, a combustion cycle and an exhaust cycle. During the intake cycle, corresponding ones of the intake valves 14 are opened immediately before the corresponding first piston 8A and the corresponding second piston 8B start to move away from each other, and a gas mixture of air and fuel is injected from the injection nozzle 51 into the corresponding cylinders 4. After the injection of the gas mixture is completed (when the first pistons 8A and the second pistons 8B are at positions most distant from each other), the corresponding intake valves 14 are closed. During the compression cycle, the gas mixture injected into the corresponding cylinders 4 is compressed by the corresponding first piston 8A and the corresponding second piston 8B approaching each other. During the combustion cycle, a corresponding one of the spark plugs 50 sparks and ignites the compressed gas mixture, so that the corresponding first piston 8A and the corresponding second piston 8B move away from each other because of the combustion of the gas mixture. During the exhaust cycle, a corresponding one of the exhaust valves 15 is opened shortly before the corresponding first piston 8A and the corresponding second piston 8B start to approach each other, and combustion gas is ejected from the corresponding cylinders 4. Immediately after exhaust of the combustion gas is completed (when the first piston 8A and the second piston 8B are at their closest approach to each other), the corresponding exhaust valve 15 is closed.

As the opposed-piston engine 1 repeatedly performs the above-mentioned four cycles, the first crankshaft 9A and the second crankshaft 9B rotate in opposite directions. The rotational power of the first crankshaft 9A is outputted from the first output shaft 3A. The rotational power of the second crankshaft 9B is outputted from the second output shaft 3B. Accordingly, the first output shaft 3A and the second output shaft 3B of the opposed-piston engine 1 rotate in opposite directions.

As shown in FIGS. 8 to 12, the opposed-piston engine 1 includes a decompressor (decompression device) 60. The decompressor 60 reduces pressures inside the cylinders 4 when the opposed-piston engine 1 starts. More specifically, the decompressor 60 reduces the pressures inside the cylinders 4 by releasing air compressed inside any of the cylinders 4 when (or immediately before) the opposed-piston engine 1 starts. The air released by the decompressor 60 is ejected to an outside of the engine block 2 via the exhaust passage 6.

Thus, by reducing, via the decompressor 60, the pressures inside the cylinders 4 when the opposed-piston engine 1 starts, it is possible to reduce a load on a starter (self-starter) of the opposed-piston engine 1 provided in the flying apparatus 101.

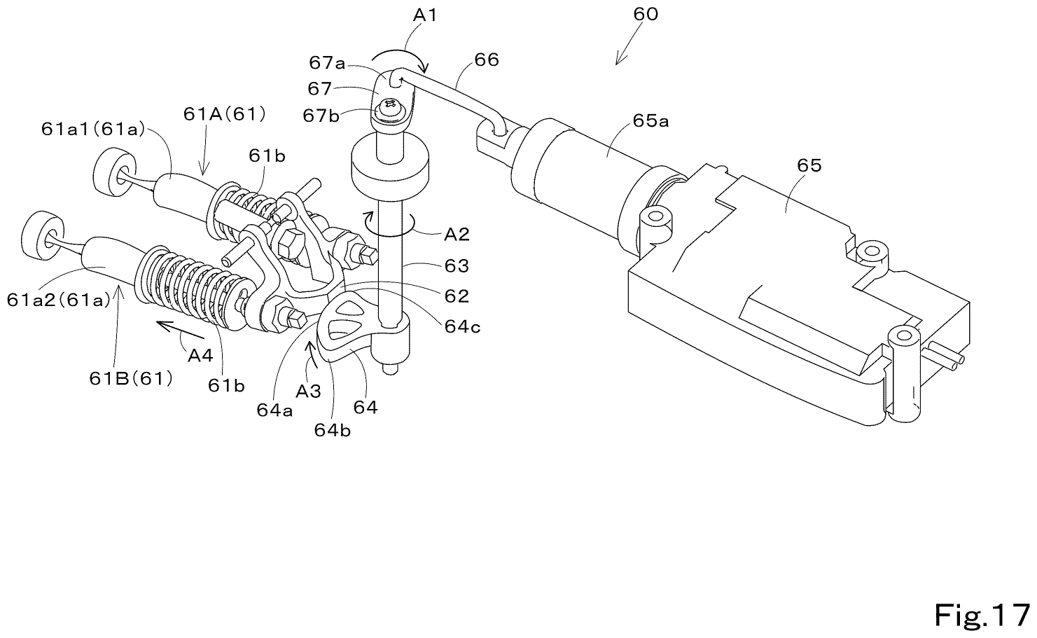

As shown in FIG. 17, the decompressor 60 includes decompression valves 61. The decompression valves 61 are each configured to release air compressed inside the corresponding cylinders 4 by moving relatively to the corresponding cylinders 4. The decompression valves 61 each include a decompression valve main body 61a and a spring 61b to bias the decompression valve main body 61a. The spring 61b biases the decompression valve main body 61a in a direction to close the decompression valve 61. The decompression valve main bodies 61a of the respective decompression valves 61 are moved by actuating a later-discussed actuator 65 against the bias forces of the springs 61b.

The decompression valves 61 include a first decompression valve 61A and a second decompression valve 61B. As shown in FIG. 9, the first decompression valve 61A and the second decompression valve 61B are provided in parallel or substantially parallel to each other and arranged at a distance from each other in the extending direction of the camshaft 21 (left-right direction). The first decompression valve 61A is configured to release air from the inside of the first cylinder structure 41 (see FIG. 7) to the outside. The second decompression valve 61B is configured to release air from the inside of the second cylinder structure 42 (see FIG. 7) to the outside.

As shown in FIG. 17, the decompressor 60 further includes a coupler 62, a shaft 63, a swing cam 64, and an actuator 65. The coupler 62 connects the decompression valve main body 61a (hereinafter referred to as “first decompression valve main body 61a1”) of the first decompression valve 61A to the decompression valve main body 61a (hereinafter referred to as “second decompression valve main body 61a2”) of the second decompression valve 61B. A cam surface 64a of the swing cam 64 abuts the coupler 62. The cam surface 64a has a substantially arcuate shape in a plane view. The swing cam 64 is fixed to the shaft 63 which extends in the up-down direction. The shaft 63 rotates about an axial center thereof extending in the up-down direction. A lower portion of the shaft 63 is located inside the engine block 2, and an upper portion of the shaft 63 is located outside the engine block 2 (see FIG. 2).

The cam surface 64a is an arcuate surface that does not have a uniform distance from the shaft 63, but has a distance from the shaft 63 which gradually increases along an arcuate direction from a first end 64b to a second end 64c. The swing cam 64 swings according to rotation of the shaft 63 and pushes the decompression valves 61. More specifically, when the swing cam 63 swings in one direction (direction of the arrow A3) according to rotation of the shaft 63, the swing cam 64 pushes the decompression valves 61 via the coupler 62.

The actuator 65 is an electric actuator. More specifically, the actuator 65 is an electric cylinder. The actuator 65 is controlled by a controller (not illustrated) which controls the engine 1. As shown in FIGS. 9, 11 and 12, the actuator 65 is provided above the second crankshaft 9B to overlap the second crankshaft 9B. As shown in FIGS. 1 and 2, the actuator 65 is located outside the engine block 2.

As shown in FIG. 17, the actuator 65 includes a rod 65a. The rod 65a is extended in a direction to approach the decompression valves 61 (rearward) and contracted in a direction away from the decompression valves 61 (forward). As shown in FIG. 9, the rod 65a extends in the first piston 8A and second piston 8B alignment direction (front-rear direction). One end of a connector 66 is attached to a distal end of the rod 65a. Another end of the connector 66 is attached to a swing plate 67. The swing plate 67 is attached to an upper portion of the shaft 63. The swing plate 67 includes a first attachment portion 67a attached to the connector 66 and a second attachment portion 67b attached to the shaft 63.

FIGS. 9 and 17 illustrates the rod 65a of the actuator 65 in an extended state. In this state, the decompression valves 61 are closed. As the rod 65a is contracted from this state, the swing plate 67 is swung in a direction of arrow A1 using the second attachment portion 67b as a fulcrum. Thus, the shaft 63 rotates in a direction of arrow A2 about the axial center thereof, and the swing cam 64 swings in a direction of arrow A3. Accordingly, the coupler 62 is pushed by the cam surface 64a of the swing cam 64. When the coupler 62 is pushed, the decompression valve main bodies 61a are pushed. Thus, the decompression valve main bodies 61a move in a direction of arrow A4 against the biasing force of the springs 61b, so that the decompression valves 61 are opened.

When the decompression valves 61 are opened and the rod 65a is extended, the swing plate 67 is swung in a direction opposite to the direction of arrow A1 using the second attachment portion 67b as a fulcrum. Thus, the shaft 63 rotates in a direction opposed to the direction of arrow A2 about the axial center thereof, and the swing cam 64 swings in a direction opposed to the direction of arrow A3. Thus, a pressure of the cam surface 64a of the swing cam 64 against the coupler 62 is released. Then, the decompression valve main bodies 61a move in a direction opposed to the direction of arrow A4 due to the biasing forces of the springs 61b, so that the decompression valves 61 are closed.

Since the first decompression valve main body 61al and the second decompression valve main body 61a2 are connected via the coupler 62, the first decompression valve main body 61al and the second decompression valve main body 61a2 move integrally with each other. Thus, it is possible to operate (open and close) two decompression valves 61 simultaneously via the single actuator 65.

Note that the decompressor 60 may have an alternative configuration in which the decompression valves 61 are opened when the rod 65a is extended and the decompression valves 61 are closed when the rod 65a is contracted, instead of the above-described configuration (in which the decompression valves 61 are opened when the rod 65a is contracted, and the decompression valves 61 are closed when the rod 65a is extended). The alternative configuration can be achieved, for example, by forming the cam surface 64a to gradually reduce a distance of the cam surface 64a from the shaft 63 along an arcuate direction from the first end 64b to the second end 64c.

As shown in FIGS. 8, 9, 11 and 12, at least a portion of the power transmission 20 is located on the same side as the first crankshaft 9A in the first piston 8A and second piston 8B alignment direction, and the decompressor 60 is located on the same side as the second crankshaft 9B in the first pistons 8A and second pistons 8B alignment direction. That is, the at least a portion of the power transmission 20 and the decompressor 60 are distributed on the first crankshaft 9A side and on the second crankshaft 9B side. In the present example embodiment, the “at least a portion of the power transmission 20” includes the camshaft 21. Thus, the camshaft 21 and the decompressor 60 are distributed on the first crankshaft 9A side and on the second crankshaft 9B side.

More specifically, the “at least a portion of the power transmission 20” includes the camshaft 21 and the first ends 22a of the pushrods 22. Thus, the camshaft 21 and the first ends 22a of the pushrods 22, and the decompressor 60 are distributed on the first crankshaft 9A side and on the second crankshaft 9B side.

As shown in FIG. 9, the decompression valves 61 are located between the first pushrod 22A and the second pushrod 22B in the extending direction (left-right direction) of the camshaft 21. The decompression valves 61 are located between the first exhaust valve 15A and the second exhaust valve 15B in the extending direction of the camshaft 21. The decompression valves 61 are located between the first crankshaft 9A and the second crankshaft 9B in the first piston 8A and second piston 8B alignment direction, and closer to the second crankshaft 9B than to the first crankshaft 9A.

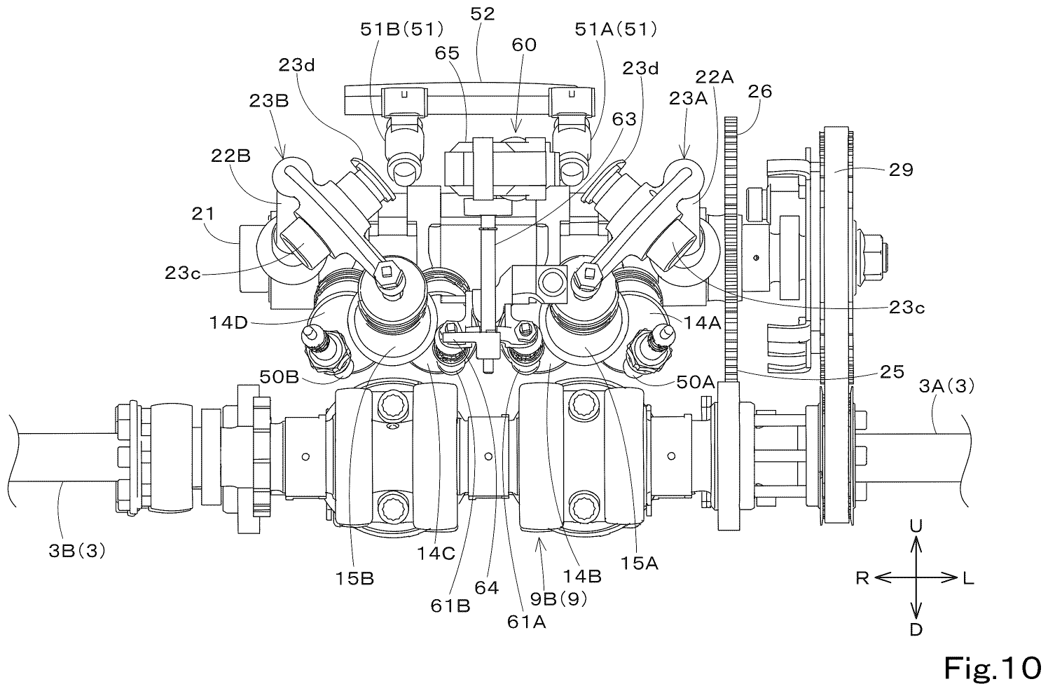

As shown in FIG. 10, the shaft 63 of the decompressor 60 is located between the first rocker arm 23A and the second rocker arm 23B. The shaft 63 extends in the up-down direction through a space between the first rocker arm 23A and the second rocker arm 23B. The shaft 63 is located above the first crankshaft 9A. As shown in FIGS. 11 and 12, the shaft 63 overlaps the second crankshaft 9B in the first piston 8A and second piston 8B alignment direction (front-rear direction).

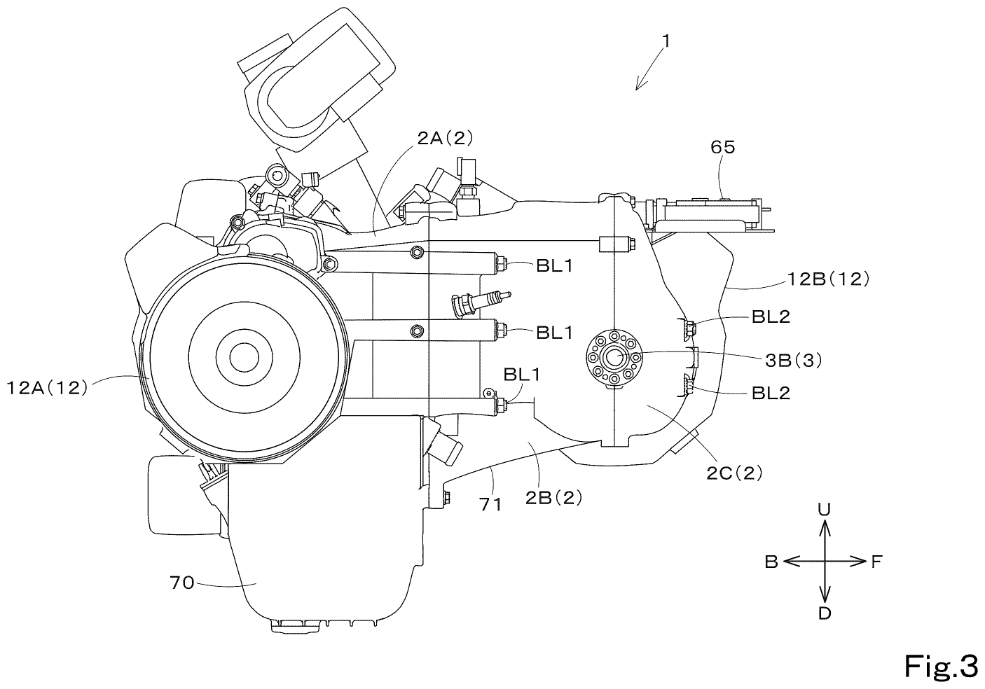

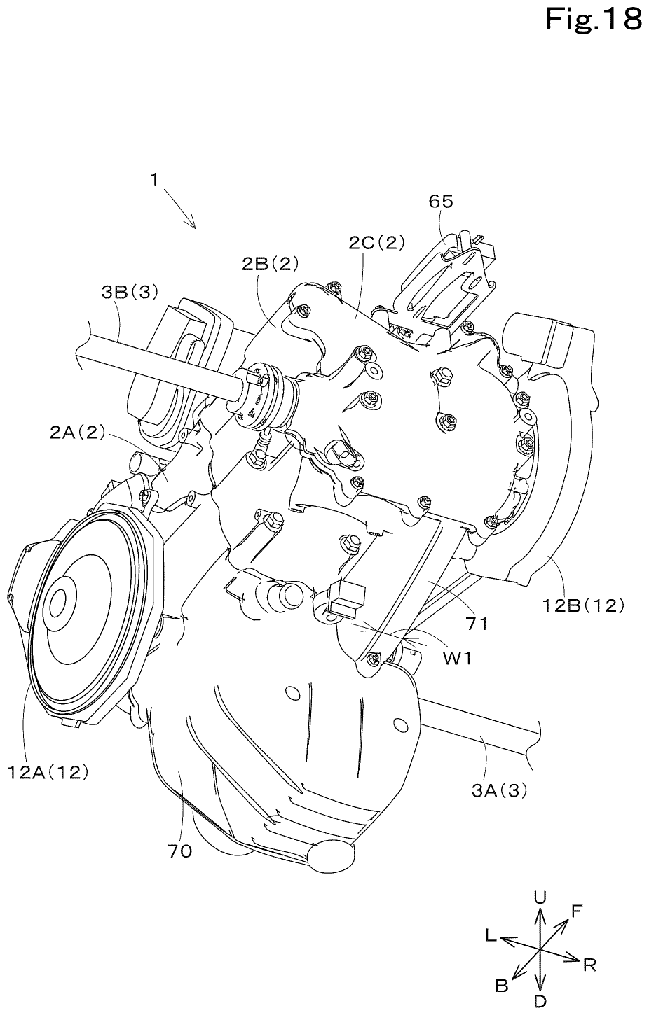

As shown in FIGS. 1 to 6 and in FIG. 18, an oil pan 70 is provided downward of the engine block 2. The engine block 2 has a width-directional first-side portion (leftward in FIG. 3) and a width-directional second-side portion arranged in a width direction thereof (front-rear direction), and the oil pan 70 is provided on only the width-directional first-side portion of the width-directional first-side and second-side portions of the engine block 2. Accordingly, the portion (leftward in FIG. 3) of the opposed-piston engine 1 which is provided with the oil pan 70 projects further downward than the portion (rightward in FIG. 3) of the opposed-piston engine 1 which is not provided with the oil pan 70. In other words, a lower end (bottom surface) of the portion of the opposed-piston engine 1 with the oil pan 70 is located lower than a lower end (bottom surface) of the portion of the opposed-piston engine 1 without the oil pan 70.

In the present example embodiment, the “width direction of the engine block 2” is the first piston 8A and second piston 8B alignment direction (front-rear direction). The “width-directional first side of the engine block 2” is a rear side of the engine block 2. The “width-directional second side of the engine block 2” is a front side of the engine block 2. That is, the oil pan 70 is provided only at the rear portion of the engine block 2 and not at the front portion of the engine block 2.

However, the “width-directional first side of the engine block 2” may be a front side of the engine block 2. In such a case, the oil pan 70 is provided only at the front portion of the engine block 2 and not at the rear portion of the engine block 2. The “width direction of the engine block 2” is not limited to the first piston 8A and second piston 8B alignment direction and may be, for example, a direction (left-right direction) perpendicular to the first piston 8A and second piston 8B alignment direction. In such a case, the oil pan 70 is provided only on either a left portion or a right portion of the engine block 2.

As previously described, the first crankshaft 9A and the second crankshaft 9B are juxtaposed in parallel or substantially parallel to each other with the space therebetween in the first piston 8A and second piston 8B alignment direction (see FIG. 9 and the like). In the present example embodiment, the first piston 8A and second piston 8B alignment direction is the width direction of the engine block 2. Thus, the first crankshaft 9A and the second crankshaft 9B are juxtaposed in parallel or substantially parallel to each other with the space therebetween in the width direction of the engine block 2. The first crankshaft 9A is provided in the width-directional first-side portion of the engine block 2. The second crankshaft 9B is provided in the width-directional second-side portion of the engine block 2. Thus, the oil pan 70 is provided only on the same side as the first crankshaft 9A and not on the same side as the second crankshaft 9B.

As previously described, the camshaft 21 is located only on the same side as the first crankshaft 9A in the first piston 8A and second piston 8B alignment direction. Thus, the oil pan 70 is located on the same side as the camshaft 21 in the first piston 8A and second piston 8B alignment direction. The oil pan 70 is provided below the camshaft 21 to overlap the camshaft 21. In other words, the camshaft 21 is located above the oil pan 70.

In the present example embodiment, the oil pan 70 is integrated with the engine block 2. In other words, the oil pan 70 includes a common component shared with the engine block 2. The common component integrally includes a portion (upper portion) defining the engine block 2 and a portion (lower portion) defining the oil pan 70. However, the oil pan 70 and the engine block 2 may include respective components separated from each other, and the component defining the oil pan 70 may be connected to a lower portion of the component defining the engine block 2.

In the present example embodiment, the oil pan 70 is integrated with the first block 2A of the engine block 2. In other words, the oil pan 70 includes a common component (single component) shared with the first block 2A. The oil pan 70 is provided downward of only the first block 2A of the three blocks (first block 2A, second block 2B and third block 2C) assembled to form the engine block 2.

As shown in FIGS. 3, 18 and the like, the engine block 2 includes an oblique portion 71. The oblique portion 71 is located at a lower portion of the engine block 2. The oblique portion 71 includes a block of the plurality of blocks assembled to define the engine block 2, which is different from the block (first block 2A) provided with the oil pan 70 downward thereof (integrated at the lower portion thereof with the oil pan 70). More specifically, the oblique portion 71 includes a block different from and adjacent to the block (first block 2A) with the oil pan 70 downward thereof (integrated at the lower portion thereof with the oil pan 70). Specifically, the oblique portion 71 is located at a lower portion of the second block 2B among the first block 2A, the second block 2B and the third block 2C.

As described above, the oil pan 70 is provided downward of (integrally formed at a lower portion of) one block (first block 2A) of the plurality of blocks. The oblique portion 71 is located at a lower portion of another block (second block 2B) of the plurality of blocks, which is adjacent to the one block (first block 2A).

As shown in FIG. 5, an inner lower surface 72 of the oblique portion 71 is inclined downward in the width direction of the engine block 2 from the width-directional second side (front side) thereof to the width-directional first side (rear side) thereof. The inner lower surface 72 of the oblique portion 71 is joined to an inner wall surface 70b of the oil pan 70 rising from an inner lower surface 70a of the oil pan 70. Accordingly, oil (lubrication oil) falling on a lower surface of the width-directional second-side portion of the engine block 2 flows along the inner lower surface 72 of the oblique portion 71 to the width-directional first-side portion of the engine block 2 (see arrow Cl of FIG. 5), flows down to the inner portion of the oil pan 70, and is collected in the inner portion of the oil pan 70.

As previously described, the oblique portion 71 is included in the second block 2B of the engine block 2. As shown in FIG. 5, the inner lower surface of the third block 2C of the engine block 2 is located higher than the inner lower surface of the second block 2B. The inner lower surface 72 of the oblique portion 71 is inclined downward from one side of the second block 2B facing the third block 2C to another side of the second block 2B facing the first block 2A. An upper end of the inner lower surface 72 of the oblique portion 71 is as high as the inner lower surface of the third block 2C. A lower end of the inner lower surface 72 of the oblique portion 71 is as high as an upper end of a side (front side) of the oil pan 70 facing the oblique portion 71. Thus, oil accumulated on the inner lower surface of the second block 2B and the inner lower surface of the third block 2C flows down from the third block 2C side to the first block 2A side, and falls to the inner portion of the oil pan 70.

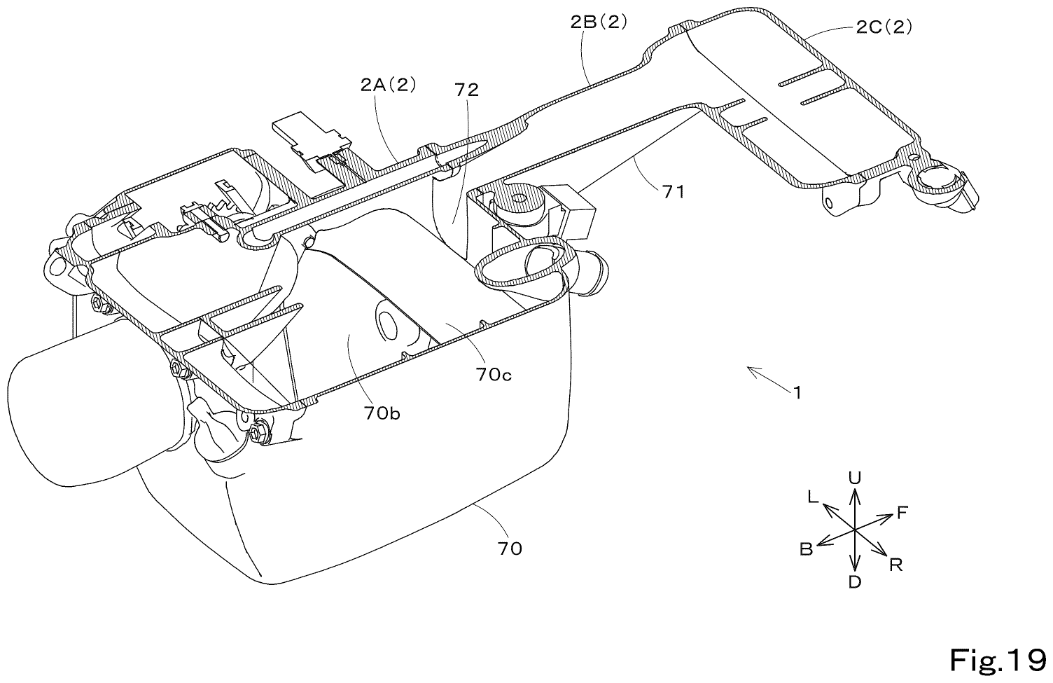

As shown in FIGS. 5 and 19, a protrusion plate 70c is provided on the inner wall surface 70b rising from the inner lower surface 70a of the oil pan 70. More specifically, the protrusion plate 70c is provided on the inner wall surface 70b at a front portion (the second-side portion in the width direction of engine block 2) of the oil pan 70.

As shown in FIG. 5, the protrusion plate 70c extends to protrude (rearward) from the inner wall surface 70b. In the present example embodiment, the protrusion plate 70c extends in a horizontal direction, but may gradually incline downward from the inner wall surface 70b. As shown in FIG. 19, the protrusion plate 70c is extended at an entire length in a depth direction (left-right direction) of the engine block 2 perpendicular to the width direction of the engine block 2. Thus, it is possible to enhance a strength of the oil pan 70.

As shown in FIG. 5, the protrusion plate 70c is provided at an upper portion of the inner wall surface 70b of the oil pan 70. An upper surface of the protrusion plate 70c is located to be lower (slightly lower) than the lower end of the inner lower surface 72 of the oblique portion 71. The oil having flown along the inner lower surface 72 of the oblique portion 71 temporarily flows down onto the upper surface of the protrusion plate 70c, and then flows down from the protrusion plate 70c toward the inner lower surface 70a of the oil pan 70. Thus, the protrusion plate 70c functions to reduce the flow (speed) of the oil downward along the oblique portion 71 toward the oil pan 70. Also, the protrusion plate 70c functions to disperse, in the depth direction of the engine block 2, the oil having flown downward along the oblique portion 71, and then cause the dispersed oil to fall down to the oil pan 70.

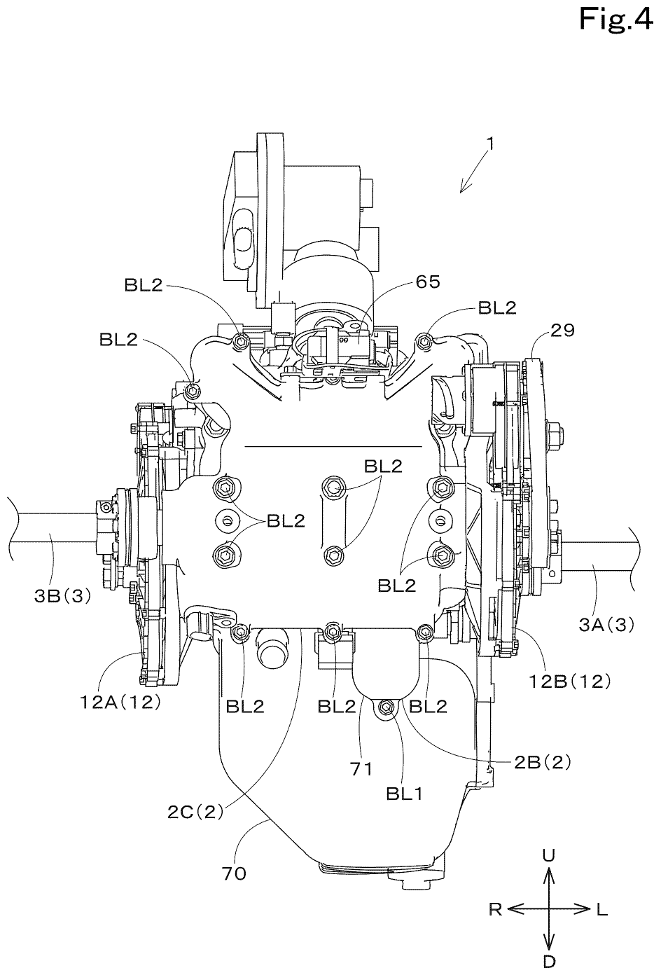

As shown in FIGS. 4, 18 and 19, the oblique portion 71 is provided only at a portion in the depth direction (left-right direction) of the engine block 2. More specifically, the oblique portion 71 is provided at a portion of the engine block 2 toward one (left) of opposite sides of the engine block 2 in the depth direction thereof which is perpendicular to the width direction thereof. In the present example embodiment, the oblique portion 71 is provided at a left portion of the engine block 2.

In the depth direction (left-right direction) of the engine block 2, a width W1 of the oblique portion 71 is less than an entire width of the engine block 2. In the depth direction (left-right direction) of the engine block 2, the width W1 of the oblique portion 71 is less than an entire width of the oil pan 70. As shown in FIGS. 4 and 19, the oblique portion 71 has a cross-sectional U-shape. Thus, the inner lower surface 72 of the oblique portion 71 is lower than the inner lower surface of a portion of the second block 2B which does not include the oblique portion 71.

Thus, since the oblique portion 71 has a cross-sectional U-shape in a narrow width, it is possible to cause the oil accumulated in the inner portion of the oblique portion 71 to flow rapidly and surely toward the oil pan 70. It is also possible to reduce or minimize the engine block 2 compared to the engine block 2 assumed to have the oblique portion 71 extended at the entire length in the depth direction of the engine block 2.

In the previous example embodiment, the configuration of the engine block 2 provided at one of opposite portions thereof with the oil pan 70 is adapted to one of opposed-piston engines 1. However, the configuration of the engine block 2 provided at one of opposite portions thereof with the oil pan 70 may be adapted to one of engines other than opposed-piston engines.

It is possible to use the opposed-piston engines 1 according to the previously mentioned example embodiments as, for example, driving sources for flying apparatuses. It is also possible to use the opposed-piston engines 1 as driving sources for devices other than flying apparatuses, for example, automobiles (including working vehicles), vessels, ships, boats, and other industrial machines.

The following describes a flying apparatus 101 which includes the opposed-piston engine 1 as an exemplary object using the opposed-piston engine 1. The flying apparatus 101 is an unmanned aerial vehicle. More specifically, the flying apparatus 101 is a multicopter called “drone”. The flying apparatus 101 may be remotely controlled to fly via wireless communication or cabled communication, or may fly by self-operating without relying on a remote controller.

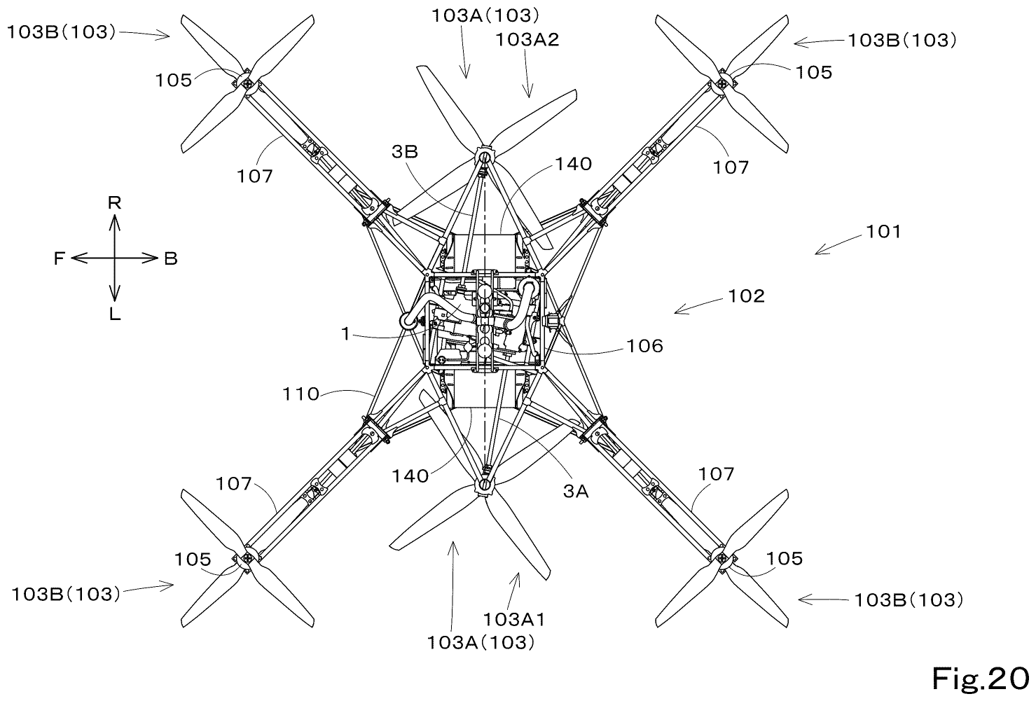

FIGS. 20 to 26 illustrate an exemplary flying apparatus 101 which includes the opposed-piston engine 1. As shown in FIGS. 20 to 23, the flying apparatus 101 includes an airframe 102, and rotors 103 attached to the airframe 102. The airframe 102 includes a main body assembly 106, and a plurality of arms 107 extending from the main body assembly 106.

The main body assembly 106 includes a plurality of frame portions assembled together. As shown in FIGS. 20 to 26, the opposed-piston engine 1 is mounted in the main body assembly 106. Skids 110 are attached to a lower portion of the main body assembly 106. When the flying apparatus 101 lands on a surface such as the ground, the skids 110 are in contact with the surface and support the airframe 102 so as to hold the airframe 102 floating above the surface.

As shown in FIG. 20, the plurality of arms 107 extends outward from the main body assembly 106 in a planar view. In the present example embodiment, four arms 107 are provided. Rotors 103 and motors 105 are attached to the respective arms 107.

The rotors 103 include main rotors 103A and sub-rotors 103B. The main rotors 103A are configured to generate lifting power to float the airframe 102. The sub-rotors 103B are configured to control a posture of the airframe 102. The main rotors 103A are attached to the main body assembly 106. The sub-rotors 103B are attached to the arms 107. The main rotors 103A are rotated via driving forces supplied from the opposed-piston engine 1. The sub-rotors 103B are rotated via driving forces supplied from the respective motors 105.

As shown in FIG. 20, in a planar view, two main rotors 103A are provided on peripheral portions of the airframe 102. Hereinafter, the two main rotors 103A are referred to as a first main rotor 103A1 and a second main rotor 103A2. The first main rotor 103A1 and the second main rotor 103A2 are located symmetrically with respect to the center of the airframe 102. The first main rotor 103A1 and the second main rotor 103A2 rotate in opposite directions to each other.

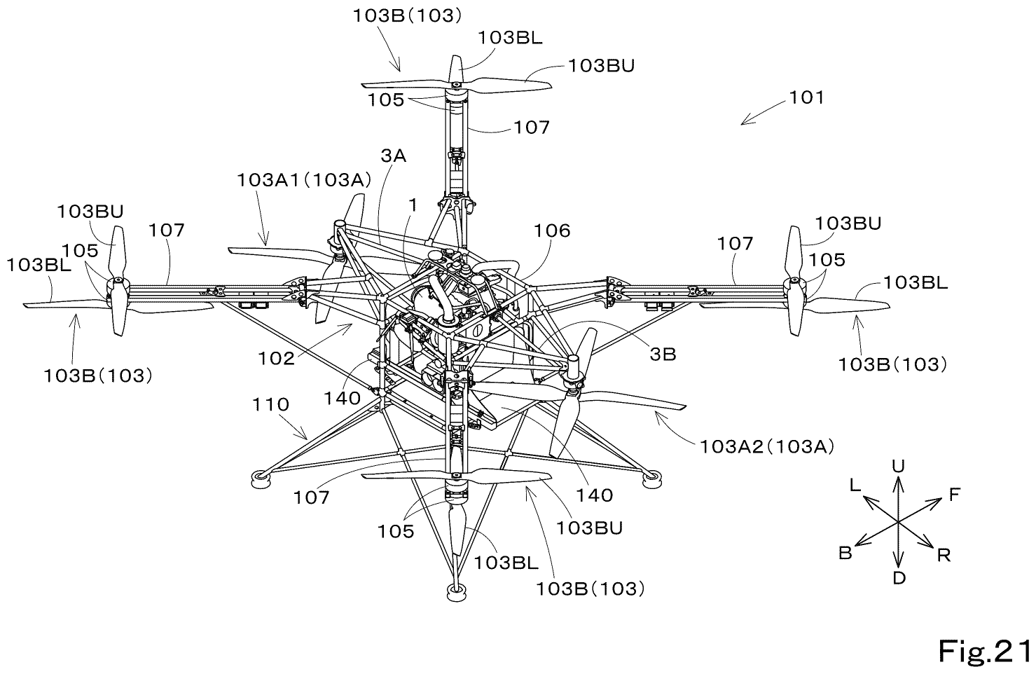

As shown in FIG. 20, in a planar view, four sub-rotors 103B are located equidistantly from the center of the airframe 102. The sub-rotors 103B are attached on the respective (four) arms 107. As shown in FIGS. 21 to 23, two sub-rotors 103B are attached to each of the arms 107. The two sub-rotors 103B include an upper rotor 103BU and a lower rotor 103BL.

The motors 105 to supply driving forces to the sub-rotors 103B are electric motors to be driven by electric power supplied from one or more batteries 146 as described later. The motors 105 include first motors 105A and second motors 105B. The first motors 105A supply driving forces to the respective upper rotors 103BU. The second motors 105B supply driving forces to the respective lower rotors 103BL.

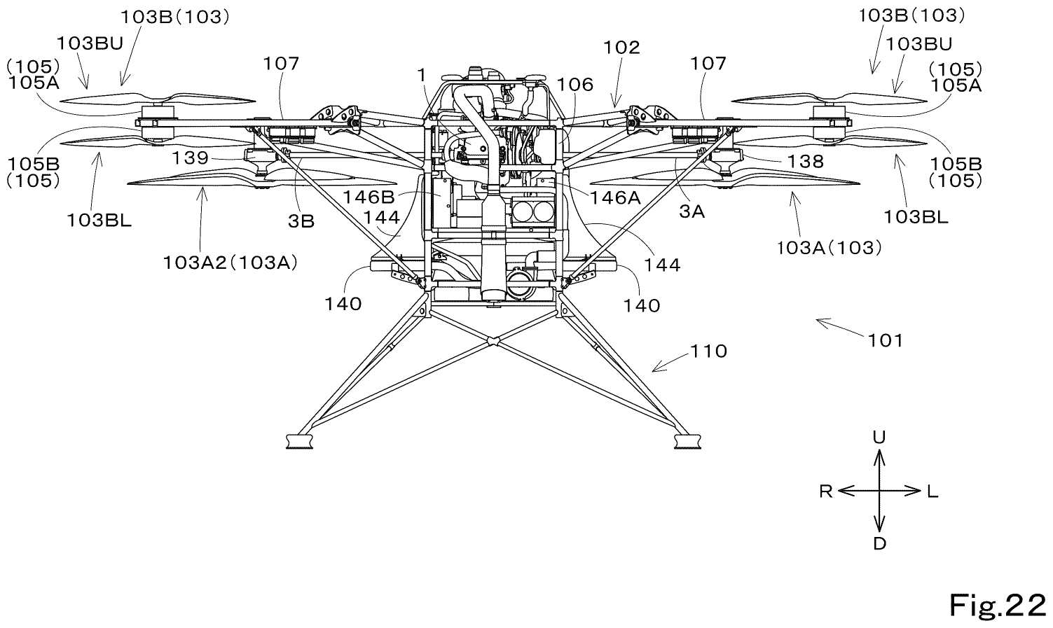

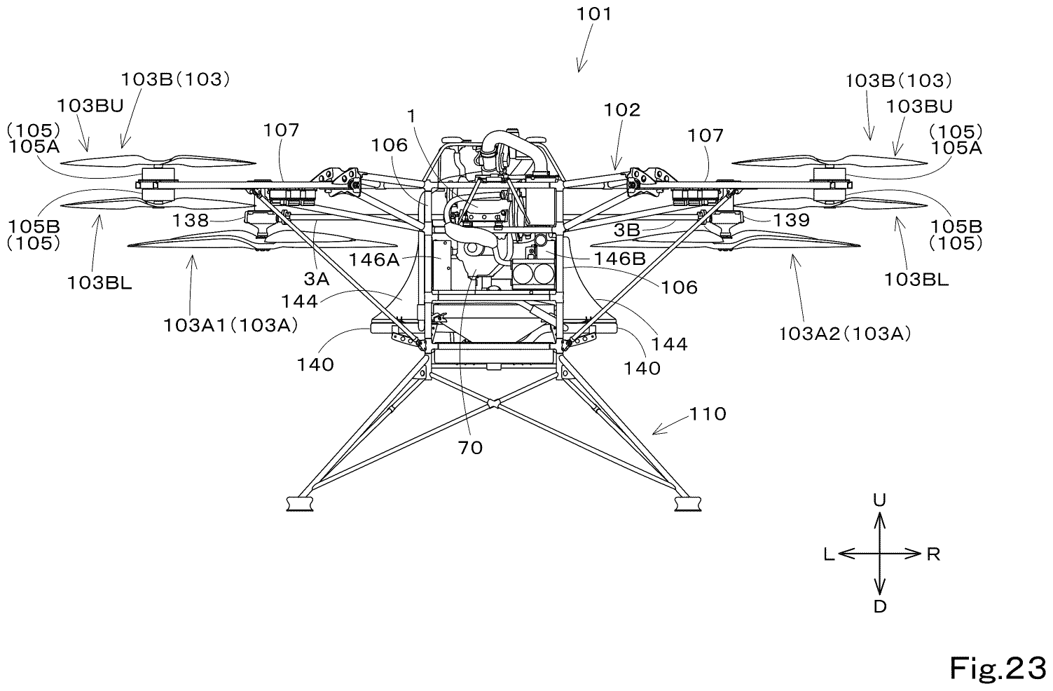

The first output shaft 3A and the second output shaft 3B of the opposed-piston engine 1 extend outward from the main body assembly 106. The first output shaft 3A supplies the driving force therefrom to the first main rotor 103A1. The second output shaft 3B supplies the driving force therefrom to the second main rotor 103A2. A rotation of the first output shaft 3A is transmitted to the first main rotor 103A1 via a first power transmission 138 such as a gear transmission (see FIGS. 22 and 23). Accordingly, the first main rotor 103A1 rotates. A rotation of the second output shaft 3B is transmitted to the second main rotor 103A2 via a second power transmission 139 such as a gear transmission (see FIGS. 22 and 23). Accordingly, the second main rotor 103A2 rotates. Thus, the two main rotors (first main rotor 103A1 and second main rotor 103A2) are driven via the two output shafts (first output shaft 3A and second output shaft 3B) of the common opposed-piston engine 1.

The flying apparatus 101 includes radiators 140 which are coolers to water-cool the engine 1. The radiators 140 are provided on sides (left side and right side) of the main body assembly 106. The flying apparatus 101 includes baffles 144 to guide downward flows of air generated by rotation of the main rotors 103A to flow toward the respective radiators 140.

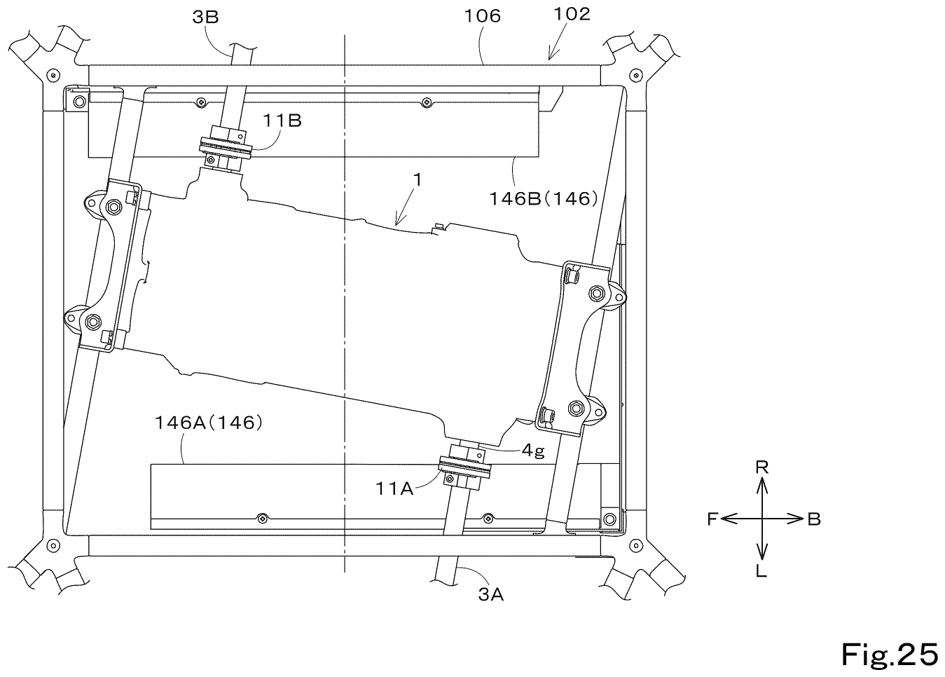

As shown in FIGS. 22 to 25, the flying apparatus 101 includes batteries 146 to store electric power to be supplied to the motors 105. As shown in FIG. 25, the batteries 146 include a first battery 146A and a second battery 146B. In a planar view, the first battery 146A is located on a side (left side) of the opposed-piston engine 1. In a planar view, the second battery 146B is located on another side (right side) of the opposed-piston engine 1. Thus, in a planar view, two batteries 146 (first battery 146A and second battery 146B) sandwich the opposed-piston engine 1 therebetween.

Electric power generated from the first generator 12A is stored in the first battery 146A. Electric power generated from the second generator 12B is stored in the second battery 146B.

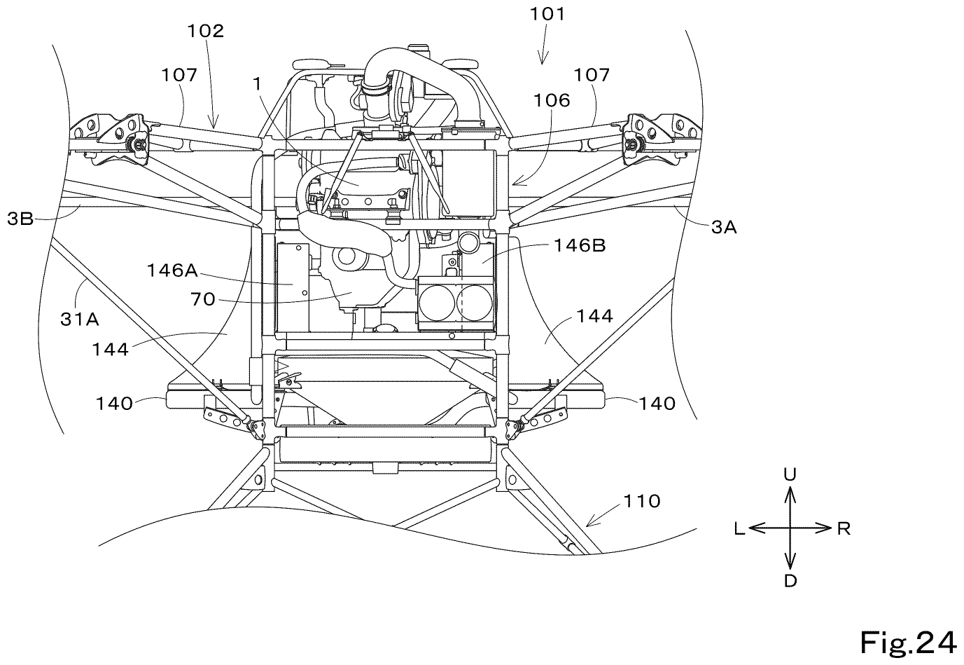

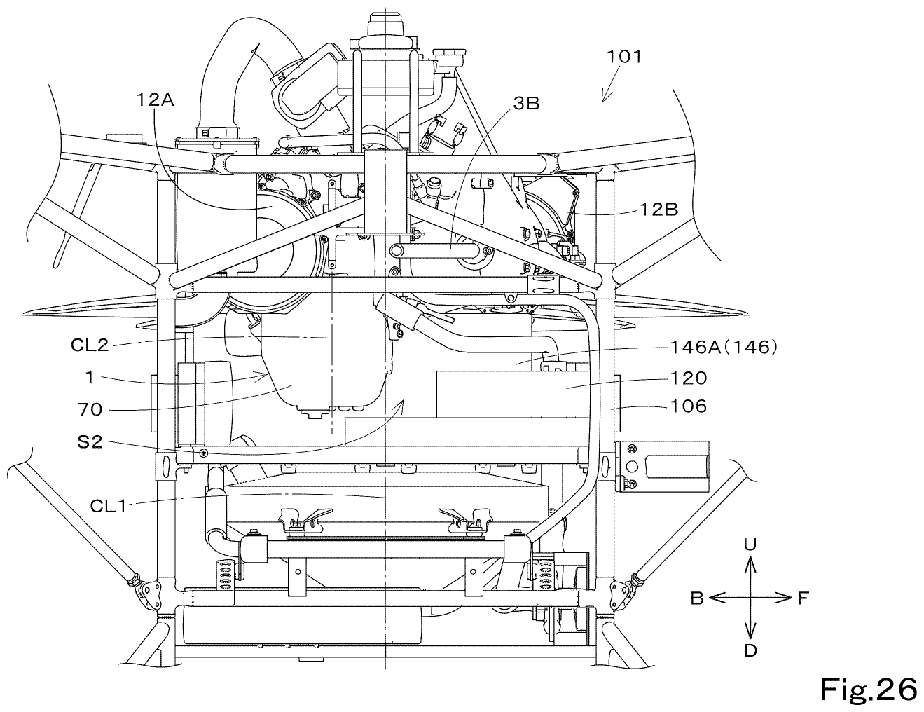

As shown in FIGS. 24 and 26, the batteries 146 (first battery 146A and second battery 146B) are located on sides of the oil pan 70. The two batteries 146 are respectively located on one side (left side) and another side (right side) of the oil pan 70. Note that in FIG. 26, only the battery (first battery 146A) located on the one side (left side) of the oil pan 70 is illustrated. In FIG. 26, the radiators 140 and the baffles 144 are omitted.

As shown in FIGS. 24 and 26, the batteries 146 overlap the oil pan 70 in the up-down direction. That is, a lower end of the oil pan 70 is lower than upper ends of the batteries 146 and higher than lower ends of the batteries 146.

As shown in FIG. 26, an electrical component 120 is mounted in or on the main body assembly 106 of the flying apparatus 101. In the present example embodiment, the electrical component 120 is a battery controller configured or programmed to control the batteries 146. The battery controller controls, for example, electrical current and voltage during charge of the batteries 146. However, the electrical component 120 is not limited to a battery controller and may include, for example, a controller configured or programmed to control driving of the opposed-piston engine 1, and/or a controller configured or programmed to control driving of the motors 105. The electrical component 120 may also include one or more pieces of electrical equipment other than controllers.

As shown in FIG. 26, the electrical component (battery controller 120) is provided below the opposed-piston engine 1 and on the second side position of the engine block 2 in the width direction (front portion) of the engine block 2. The electrical component 120 overlaps the oil pan 70 in the up-down direction. That is, an upper end of the electrical component 120 is higher than the lower end of the oil pan 70, and lower than an upper end of the oil pan 70.

As previously described, the opposed-piston engine 1 includes the oil pan 70 only on the width-directional first-side portion of the engine block 2 of the width-directional first-side and second-side portions thereof. Thus, a space S2 is created below the width-directional second-side portion of the engine block 2 (which is not provided with the oil pan 70), and the electrical component 120 is located in the space S2. Accordingly, since the opposed-piston engine 1 includes the oil pan 70 that is only provided on the width-directional first-side portion of the engine block 2, it is possible to ensure a space below the width-directional second-side portion of the engine block 2 to provide the electrical component 120 therein.

As shown in FIG. 26, the oil pan 70 of the opposed-piston engine 1 is offset to one side (rear side) in a horizontal direction (rearward) from an up-down directed central axis CL1 of the main body assembly 106 with the engine 1 mounted thereon or therein. That is, in the opposed-piston engine 1, an up-down directed central axis CL2 of the oil pan 70 is decentered relative to the up-down directed central axis CL1 of the main body assembly 106. Thus, it is possible to ensure the horizontally wide space S2 in an internal space of the main body assembly 106 and below the width-directional second-side portion of the engine block 2, so that it is possible to easily provide piece(s) of equipment including the electrical component 120 in the space S2.

The following summarizes significant configurations and effects of opposed-piston engines 1 according to the above-mentioned example embodiments and flying apparatuses 101 including the opposed-piston engines 1.

An opposed-piston engine 1 includes a cylinder 4, a first piston 8A provided in the cylinder 4, a second piston 8B provided in the cylinder 4 and opposed to the first piston 8A, a first crankshaft 9A to rotate as the first piston 8A reciprocates, a second crankshaft 9B to rotate as the second piston 8B rotates, at least one valve 13 to perform an operation to intake or exhaust air into or from the cylinder 4, and a power transmission 20 to transmit a rotational power of the first crankshaft 9A to the at least one valve 13 so as to cause the at least one valve 13 to perform the operation. The first crankshaft 9A and the second crankshaft 9B are juxtaposed with a space therebetween in an alignment direction in which the first pistons 8A and the second pistons 8B are aligned. The power transmission 20 extends in the alignment direction to a position corresponding to the first crankshaft 9A and to a position corresponding to the second crankshaft 9B across the space therebetween.

With this configuration, the power transmission 20 which transmits the rotational power of the first crankshaft 9A to the at least one valve 13 so as to cause the at least one valve 13 to perform the operation extends in the alignment direction to the position corresponding to the first crankshaft 9A and to the position corresponding to the second crankshaft 9B across the space therebetween, it is possible to reduce or minimize the power transmission 20 to transmit the rotational power of the crankshafts 9 to the at least one valve. For example, it is possible to reduce or minimize the power transmission 20 compared to the valve driving mechanism including respective timing belts looped over respective crank pulleys of two crankshafts.

The power transmission 20 includes a camshaft 21 to rotate as the first crankshaft 9A rotates, at least one pushrod 22 to reciprocate as the camshaft 21 rotates, and at least one rocker arm 23 to connect the at least one pushrod 22 to the at least one valve 13. A first end 22a of opposite ends of the at least one pushrod 22 is provided on a same side as the first crankshaft 9A, a second end 22b of the opposite ends of the at least one pushrod 22 is provided on a same side as the second crankshaft 9B, and the at least one rocker arms 23 on a same side as the second crankshaft 9B operably connects the second end 22b of the at least one pushrod 22 to the at least one valve 13.

According to this configuration, a mechanism operably connected to the first end 22a of the at least one pushrod 22 and a mechanism operably connected to the second end 22b of the at least one pushrod 22 are distributed on the first crankshaft 9A side and on the second crankshaft 9B side. The at least one rocker arm 23 defining the mechanism operably connected to the second end 22b of the at least one pushrod 22 is provided on a same side as the second crankshaft 9B, so that it is possible to ensure a space to provide the camshaft 21 on a same side as the first crankshaft 9A.

The camshaft 21 includes a single camshaft provided on a same side as the first crankshaft 9A in the alignment direction.

According to this configuration, it is possible to reduce a space necessary to provide the camshaft 21 compared to a configuration in which camshafts 21 are provided on a same side as the first crankshaft 9A and on a same side as the second crankshaft 9B. The camshaft 21 is provided on a same side as the first crankshaft 9A and the at least one rocker arm 23 is provided on a same side as the second crankshaft 9B, so that components of the power transmission are distributed in a well-balanced manner on the first crankshaft 9A side and on the second crankshaft 9B side. Thus, it is possible to reduce or minimize the opposed-piston engine 1.

The at least one valve 13 includes the intake valve 14 and the exhaust valve 15. The intake valve 14 and the exhaust valve 15 are configured to perform the respective operations as the single camshaft 21 rotates.

According to this configuration, the intake valve 14 and the exhaust valve 15 perform the respective operations as the single camshaft 21 rotates, so that it is possible to further reduce or minimize an operating mechanism including the intake valve 14 and the exhaust valve 15.

The camshaft 21 includes a shaft 30 and at least one cam 31 provided on the shaft 30, and the first end of the at least one pushrod 22 abuts the at least one cam 31.

According to this configuration, the first end of the at least one pushrods 22 abuts the at least one cam 31 of the camshaft 21, so that the at least one cam 31 of the camshaft 21 which is the mechanism operably connected to the first end 22a of the at least one pushrod 22 and the at least one rocker arm 23 which is the mechanism operably connected to the second end 22b of the at least one pushrod 22 are distributed in a well-balanced manner on the first crankshaft 9A side and on the second crankshaft 9B side.

A proximal end of a first valve that is one of the intake valve 14 or the exhaust valve 15 abuts the rocker arm 23, and a proximal end of a second valve that is another of the intake valve 14 or the exhaust valve 15 is located at a position to be pushed by the at least one cam 31.

According to this configuration, it is possible to connect the first valve that is one of the intake valve 14 or the exhaust valve 15 to the at least one rocker arm 23, and to connect the second valve that is another of the intake valve 14 or the exhaust valve 15 to the camshaft 21.

The first valve is the exhaust valve 15, and the second valve is the intake valve 14.

According to this configuration, it is possible to operably connect the exhaust valve 15 to the at least one rocker arm 23, and to operably connect the intake valve 14 to the camshaft 21.

The first piston 8A and the second piston 8B are aligned in a horizontal direction. The camshaft 21 is provided above the first crankshaft 9A.

According to this configuration, with the first piston 8A and the second piston 8B aligned in the horizontal direction, it is possible to make a height of the opposed-piston engine 1 lower. By providing the camshaft 21 above the first crankshaft 9A, it is possible to smoothly transmit power at a short distance from the first crankshaft 9A to the camshaft 21.

The at least one pushrod 22 includes a first pushrod 22A and a second pushrod 22B. The at least one cam 31 includes a first cam 31A and a second cam 31B spaced at a distance from each other in the extending direction of the camshaft 21. The first end of the first pushrod 22A abuts the first cam 31A, and the first end of the second pushrod 22B abuts the second cam 31B.

According to this configuration, it is possible to cause both the first pushrod 22A and the second pushrod 22B to reciprocate as the single camshaft 21 rotates.

An opposed-piston engine 1 includes a cylinder 4, a first piston 8A provided in the cylinder 4, a second piston 8B provided in the cylinder 4 and opposed to the first piston 8A, the first crankshaft 9A to rotate as the first piston 8A rotates, a second crankshaft 9B to rotate as the second pistons 8B rotates, at least one valve 13 to perform an operation to intake or exhaust air into or from the cylinder 4, a power transmission 20 to transmit a rotational power of the first crankshaft 9A to the at least one valve 13 so as to cause the at least one valve 13 to perform the operation, and a decompressor 60 to reduce a pressure in the cylinder 4 when the opposed-piston engine 1 is started. The first crankshaft 9A and the second crankshaft 9B are juxtaposed with a space therebetween in an alignment direction in which the first piston 8A and the second piston 8B are aligned. At least a portion of the power transmission 20 is located on a same side as the first crankshaft 9A in the alignment direction, and the decompressor 60 is located on a same side as the second crankshaft 9B in the alignment direction.

According to this configuration, the decompressor 60 and the at least a portion of the power transmission 20 to transmit the rotational power of the first crankshaft 9A to the valves 13 so as to cause the at least one valve 13 to perform the operation are provided at a distance from each other, so that it is possible to reduce or minimize the opposed-piston engine 1 including the decompressor 60. More specifically, the decompressor 60 and the at least a portion of the power transmission 20 are distributed on the first crankshaft 9A side and on the second crankshaft 9B side such that the corresponding components are provided in a well-balanced manner, and such that it is possible to reduce or minimize the opposed-piston engine 1.

The power transmission 20 includes a camshaft 21 to rotate as the first crankshaft 9A rotates, at least one pushrod 22 to reciprocate as the camshaft 21 rotates, and at least one rocker arm 23 to connect the at least one pushrod 22 and the at least one valve 13.

According to this configuration, it is possible to transmit the rotation power of the first crankshaft 9A to the at least one valve 13 via the camshaft 21, the at least one pushrod 22 and the at least one rocker arm 23.

A first end of opposite ends of the at least one pushrod 22 and the camshaft 21 are provided on a same side as the first crankshaft 9A.

According to this configuration, the decompressor 60 is provided on a same side as the second crankshaft 9B, and the first end of the pushrods 22 and the camshaft 21 are located on a same side as the first crankshaft 9A. Thus, the decompressor 60 and the camshaft 21 are distributed in a well-balanced manner on the first crankshaft 9A side and on the second crankshaft 9B side. Thus, it is possible to reduce or minimize the opposed-piston engine 1.

A second end of the opposite ends of the at least one pushrod 22 is provided on a same side as the second crankshaft 9B, and the at least one rocker arm 23 on a same side as the second crankshaft 9B operably connects the second end of the at least one pushrod 22 to the at least one valve 13.

According to this configuration, the first end of the at least one pushrod 22 and the camshaft 21 are provided on a same side as the first crankshaft 9A, and the second end of the at least one pushrod 22 and the at least one rocker arm 23 are provided on a same side as the second crankshaft 9B. Thus, the camshaft 21 and the at least one rocker arm 23 are distributed in a well-balanced manner on the first crankshaft 9A side and on the second crankshaft 9B side.

The camshaft 21 includes a single camshaft, the at least one valve 13 includes at least one intake valve 14 and at least one exhaust valve 15, and the at least one intake valve 14 and the at least one exhaust valve 15 perform the respective operations as the single camshaft 21 rotates.

According to this configuration, the at least one intake valve 14 and the at least one exhaust valve 15 perform the respective operations as the single camshaft 21 rotates, so that it is possible to reduce or minimize an operating mechanism to operate the at least one intake valve 14 and the at least one exhaust valve 15.

The at least one pushrod 22 includes the first pushrod 22A and the second pushrod 22B which are arranged at a distance from each other in an extending direction of the camshaft 21. The decompressor 60 includes a decompression valve 61 to move relative to the cylinder 4. The decompression valve 61 is provided between the first pushrod 22A and the second pushrod 22B in the extending direction of the camshaft 21.

According to this configuration, with the decompression valve 61 between the first pushrod 22A and the second pushrod 22B in the extending direction of the camshaft 21, it is possible to keep the pushrods 22 from interfering with an operating mechanism to operate the decompression valve 61. It is possible to effectively use a space between the first pushrod 22A and the second pushrod 22B (use the space for providing the decompression valve 61), so that it is possible to reduce or minimize the opposed-piston engine 1.

The at least one exhaust valve 15 includes a first exhaust valve 15A and a second exhaust valve 15B which are arranged at a distance from each other in the extending direction of the camshaft 21. The decompression valve 61 is provided between the first exhaust valve 15A and the second exhaust valve 15B in the extending direction of the camshaft 21.

According to this configuration, with the decompression valve 61 provided between the first exhaust valve 15A and the second exhaust valve 15B in the extending direction of the camshaft 21, it is possible to provide the operating mechanism of the decompression valve 61 while keeping the operating mechanism from interfering with the exhaust valves 15. It is possible to effectively use a space between the first exhaust valve 15A and the second exhaust valve 15B (use the space for providing the decompression valve 61), so that it is possible to reduce or minimize the opposed-piston engine 1.

The decompression valve 61 is provided between the first crankshaft 9A and the second crankshaft 9B in the extending direction of the camshaft 21 and closer to the second crankshaft 9B than to the first crankshaft 9A.

According to this configuration, it is possible to keep the decompression valve 61 from interfering with the power transmission 20 which is located on a same side as the first crankshaft 9A.

The at least one rocker arm 23 includes a first rocker arm 23A connected to the first pushrod 22A and a second rocker arm 23B connected to the second pushrod 22B. The decompressor 60 includes a shaft 63 rotating about an axial center extending in the up-down direction, and a swing cam 64 which is swung to push the decompression valve 61 as the shaft 63 rotates. The shaft 63 is provided between the first rocker arm 23A and the second rocker arm 23B.

According to this configuration, it is possible to provide the operating mechanism to operate the decompression valve 61 using a space between the first rocker arm 23A and the second rocker arm 23B, so that a large space is not necessary to provide the decompressor 60.

Although example embodiments of the present invention have been described above, the example embodiments disclosed herein are just illustrative in every aspect and not restrictive. The scope of the present invention is defined not by the foregoing description but by the appended claims, and all modifications made within the scope of the claims and its equivalents are intended to be encompassed herein.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An opposed-piston engine comprising:
a cylinder;
a first piston provided in the cylinder;
a second piston provided in the cylinder and opposed to the first piston;
a first crankshaft to rotate as the first piston reciprocates;
a second crankshaft to rotate as the second piston reciprocates;
at least one valve to perform an operation to intake or exhaust air into or from the cylinder; and
a power transmission to transmit a rotational power of the first crankshaft to the at least one valve so as to cause the at least one valve to perform the operation; wherein
the first crankshaft and the second crankshaft are juxtaposed with a space therebetween in an alignment direction in which the first piston and the second piston are aligned; and
the power transmission extends in the alignment direction to a position corresponding to the first crankshaft and to a position corresponding to the second crankshaft across the space therebetween.

2. The opposed-piston engine according to claim 1, wherein
the power transmission includes a camshaft to rotate as the first crankshaft rotates, at least one pushrod to reciprocate as the camshaft rotates, and at least one rocker arm to connect the at least one pushrod to the at least one valve; wherein
a first end of opposite ends of the at least one pushrod is provided on a same side as the first crankshaft;
a second end of the opposite ends of the at least one pushrod is provided on a same side as the second crankshaft; and
the at least one rocker arm on a same side as the second crankshaft operably connects the second end of the at least one pushrod to the at least one valve.

3. The opposed-piston engine according to claim 2, wherein
the camshaft includes a single camshaft provided on a same side as the first crankshaft in the alignment direction.

4. The opposed-piston engine according to claim 3, wherein
the at least one valve includes an intake valve and an exhaust valve; and
the intake valve and the exhaust valve are configured to perform the respective operations as the single camshaft rotates.

5. The opposed-piston engine according to claim 2, wherein
the camshaft includes a shaft and at least one cam provided on the shaft; and
the first end of the at least one pushrod abuts the at least one cam.

6. The opposed-piston engine according to claim 4, wherein
the camshaft includes a shaft and at least one cam provided on the shaft;
the first end of the at least one pushrod abuts the at least one cam; and
a proximal end of a first valve that is one of the intake valve or the exhaust valve abuts the at least one rocker arm, and a proximal end of a second valve that is another of the intake valve or the exhaust valve abuts a rocker which is interlocked with the at least one cam.

7. The opposed-piston engine according to claim 6, wherein
the first valve is the exhaust valve; and
the second valve is the intake valve.

8. The opposed-piston engine according to claim 2, wherein
the first piston and the second piston are aligned in a horizontal direction; and
the camshaft is provided above the first crankshaft.

9. The opposed-piston engine according to claim 5, wherein
the at least one pushrod includes a first pushrod and a second pushrod;
the at least one cam includes a first cam and a second cam spaced at a distance from each other in an extending direction of the camshaft;
the first end of the first pushrod abuts the first cam; and
the first end of the second pushrod abuts the second cam.
